(19) United States
(12) Patent Application Publication
(10) Pub. No.: US 2026/0066735 A1
(43) Pub. Date: Mar. 5, 2026

(54) ELECTRIC WORK MACHINE

(71) Applicant: MAKITA CORPORATION, Anjo-shi (JP)

(72) Inventor: Fuminari FUJII, Anjo-shi (JP)

(73) Assignee: MAKITA CORPORATION, Anjo-shi (JP)

(21) Appl. No.: 19/310,550

(22) Filed: Aug. 26, 2025

(30) Foreign Application Priority Data
Aug. 28, 2024 (JP) 2024-146805

(51) Int. Cl. H02K 3/52; B25F 5/02; H02K 7/14; H02K 9/06; H02K 11/215; H02K 21/16

(52) U.S. Cl. CPC H02K 3/522; H02K 7/145; H02K 9/06; H02K 11/215; H02K 21/16; B25F 5/02; H02K 2203/09

(57) ABSTRACT

One aspect of the present disclosure provides an electric work machine with a brushless DC motor. A stator of the brushless DC motor includes a conductive member stacked on a yoke of the stator via an insulator of the stator in an axial direction of a rotation axis of the brushless DC motor. A first connector in the conductive member is aligned with a second connector in the conductive member across the axial direction. The first connector and the second connector overlap an axially extended region of coils on the stator, when viewed from a direction perpendicular to the axial direction. The first connector and the second connector are coupled respectively to a first end and a second end of at least one magnetic wire of the coils.

### CROSS-REFERENCE TO RELATED APPLICATIONS

The present application claims the benefit of Japanese Patent Application No. 2024-146805 filed on Aug. 28, 2024 with the Japan Patent Office, the entire disclosure of which is incorporated herein by reference.

### BACKGROUND

The present disclosure relates to an electric work machine with a brushless DC motor.

Japanese Patent No. 7242214 discloses an electric work machine with a brushless DC motor.

The brushless DC motor includes a rotor and a stator. The rotor includes magnets. The stator surrounds the rotor. The stator includes coils. The coils are formed from a magnet wire. The magnet wire has a start end and a terminal end. The start end and the terminal end are connected to the same conductive member with the start end and the terminal end being offset from each other in an axial direction of the rotor.

### SUMMARY

In the above-described electric work machine, since the start end and the terminal end of the magnet wire are offset from each other in the axial direction of the rotor, the axial dimension of the brushless DC motor may increase. As a result, the electric work machine may become larger.

On the other hand, users of the electric work machines are demanding smaller electric work machines.

In one aspect of the present disclosure, it is desirable to be able to inhibit an electric work machine with a brushless DC motor from increasing in size.

In the present disclosure, it should be noted that the terms such as “first” and “second” are intended simply to distinguish elements from each other, and are not intended to limit the order or the number of the elements. The first element may be referred to as the second element, and similarly, the second element may be referred to as the first element. In addition, the first element may be included without the second element, and similarly, the second element may be included without the first element.

One aspect of the present disclosure provides an electric work machine including a brushless DC motor.

The brushless DC motor includes a rotor and a stator. The rotor is configured to rotate about a rotation axis. The stator surround the rotor.

The stator includes a stator core, an insulator, coils, and a conductive member.

The stator core includes a yoke and teeth. The yoke surrounds the rotor. The teeth protrude radially inward from the yoke.

The insulator covers at least a portion of the stator core. The coils are formed from at least one magnet wire wound around the teeth via the insulator.

The conductive member includes a first connector and a second connector. The first connector is coupled to a first end of one of the at least one magnet wire. The second connector is coupled to a second end of the one of the at least one magnet wire.

The conductive member is stacked on the yoke via the insulator in an axial direction of the rotation axis.

The first connector is offset from the second connector in a circumferential direction of the rotation axis but aligned with the second connector across the axial direction. The first connector and the second connector overlap an axially extended region of the coils, when viewed from a direction perpendicular to the axial direction.

In the brushless DC motor of the electric work machine as above, the axial size of the brushless DC motor can be reduced since (i) the position of the first connector coincides with the position of the second connector in the axial direction and (ii) the first connector and the second connector overlap the axially extended region of the coils, when viewed from the direction perpendicular to the axial direction. Accordingly, the electric work machine can be inhibited from increasing in size.

### BRIEF DESCRIPTION OF THE DRAWINGS

Example embodiments of the present disclosure will be described hereinafter with reference to the accompanying drawings, in which:

FIG. 1 is an external view of an electric work machine according to an example first embodiment;

FIG. 2 is a first perspective view of a motor unit in the electric work machine of the first embodiment;

FIG. 3 shows an exploded perspective view of the motor unit, which corresponds to the first perspective view of the motor unit in the first embodiment;

FIG. 4 shows an exploded perspective view of a stator, a rotor, a fan, and a circuit board, which corresponds to the first perspective view of the motor unit in the first embodiment;

FIG. 5 is a perspective view showing an inner structure of a left partial housing of the first embodiment;

FIG. 6 is a second perspective view of the motor unit in the electric work machine of the first embodiment;

FIG. 7 shows an exploded perspective view of the motor unit, which corresponds to the second perspective view of the motor unit in the first embodiment;

FIG. 8 shows an exploded perspective view of the stator, the rotor, the fan, and the circuit board, which corresponds to the second perspective view of the motor unit in the first embodiment;

FIG. 9 shows an exploded perspective view of a first insulator, a stator core, a second insulator, and a conductive member, which corresponds to the first perspective view of the motor unit in the first embodiment;

FIG. 10 is a perspective view of the stator of the first embodiment, showing coils and conductive members;

FIG. 11 is an enlarged view of a W-phase conductive member of the first embodiment, showing its portion including fusing terminals;

FIG. 12 is an explanatory view of the coils and the conductive members of the stator of the first embodiment, when viewed from rear;

FIG. 13 is an explanatory diagram schematically showing an electrical connection structure of the coils and the conductive members in the stator of the first embodiment;

FIG. 14 is an explanatory view of coils and conductive members of a stator of a second embodiment, when viewed from rear;

FIG. 15 is an enlarged view of a second W-phase conductive member of the second embodiment, showing its portion including fusing terminals;

FIG. 16 is an explanatory diagram schematically showing an electrical connection structure of coils and conductive members in the stator of the second embodiment;

FIG. 17 is an explanatory diagram schematically showing coils and conductive members in a stator of a third embodiment, when viewed from rear;

FIGS. 18A through 18C are explanatory diagrams of third conductive members of the third embodiment, FIG. 18A showing a configuration of a third U-phase conductive member, FIG. 18B showing a configuration of a third V-phase conductive member, and FIG. 18C showing a configuration of a third W-phase conductive member;

FIG. 19 is an exploded view schematically showing how the third conductive members and insulating members of the third embodiment are stacked on each other;

FIG. 20 is an explanatory diagram schematically showing an electrical connection structure of the coils and the conductive members in the stator of the third embodiment;

FIG. 21 is an explanatory diagram schematically showing coils and conductive members in a stator of a fourth embodiment, when viewed from rear;

FIGS. 22A through 22C are explanatory diagrams of fourth conductive members of the fourth embodiment, FIG. 22A showing a configuration of a fourth U-phase conductive member, FIG. 22B showing a configuration of a fourth V-phase conductive member, and FIG. 22C showing a configuration of a fourth W-phase conductive member;

FIG. 23 is an exploded view schematically showing how the fourth conductive members and the insulating members of the fourth embodiment are stacked on each other; and

FIG. 24 is an explanatory diagram schematically showing an electrical connection structure of the coils and the conductive members in the stator of the fourth embodiment.

### DETAILED DESCRIPTION OF EXEMPLARY EMBODIMENTS

### 1. Overview of Embodiments One embodiment may provide an electric work machine (or an electric power tool, or an electric-powered equipment, or a job-site device) including at least any one of:

Feature 1: a brushless DC motor;
Feature 2: the brushless DC motor includes a rotor configured to rotate about a rotation axis;
Feature 3: the brushless DC motor includes a stator surrounding the rotor;
Feature 4: the stator includes a stator core;
Feature 5: the stator core includes a yoke surrounding the rotor;
Feature 6: the stator core includes teeth protruding radially inward from the yoke;
Feature 7: the stator includes an insulator covering at least a portion of the stator core;
Feature 8: the stator includes coils formed from at least one magnet wire wound around the teeth via the insulator;
Feature 9: the stator includes a conductive member;
Feature 10: the conductive member includes a first connector coupled (or connected) to a first end of one of the at least one magnet wire;
Feature 11: the conductive member includes a second connector coupled (or connected) to a second end of the one of the at least one magnet wire;
Feature 12: the conductive member is stacked on the yoke via the insulator in an axial direction of the rotation axis;
Feature 13: the first connector is offset from the second connector in a circumferential direction of the rotation axis but aligned with the second connector across the axial direction (or in a radial direction of the rotation axis);
Feature 14: the first connector and the second connector overlap an axially extended region of the coils, when viewed from a direction perpendicular to the axial direction.

In the electric work machine including at least Features 1 through 14, the brushless DC motor can inhibit increase in size in the axial direction due to the first connector and the second connector (i) not being offset from each other and (ii) overlapping the axially extended region of the coils, when viewed from the direction perpendicular to the axial direction. As a result, the electric work machine can be inhibited from increasing in size.

One embodiment may include, in addition to or in place of at least any one of Features 1 through 14, at least any one of:
Feature 15: the first connector and the second connector are each formed of a plate member;
Feature 16: the plate member is bent such that its cross section has a U-shape;
Feature 17: the first connector and the second connector are each arranged such that a first extension direction connecting an open end and a closed end of the U-shape is arranged parallel to the axial direction;
Feature 18: the first connector is coupled (or connected) to the first end arranged in an inside of the U-shape; and
Feature 19: the second connector is coupled (or connected) to the second end arranged in the inside of the U-shape.

One embodiment may include, in addition to or in place of at least any one of Features 1 through 19,
Feature 20: the first connector and the second connector are arranged such that a gap between the first connector and the second connector in the circumferential direction is larger than or equal to a width of one of the teeth in the circumferential direction.

In the electric work machine including at least Features 1 through 14 and 20, it is possible to ensure the gap between the first connector and the second connector greater than or equal to a specified level. This makes it easy to ensure a working space of coupling the first connector to the first end and a working space of coupling the second connector to the second end. As a result, it is possible to reduce complexity of coupling the first end and the second end respectively to the first connector and the second connector.

One embodiment may include, in addition to or in place of at least any one of Features 1 through 20,
Feature 21: the first connector and the second connector are arranged such that a gap between the first connector and the second connector in the circumferential direction is smaller than a width of one of the teeth in the circumferential direction.

In the electric work machine including at least Features 1 through 14 and 21, the first connector and the second connector can be close to each other, and the at least one magnet wire can be routed such that the first end and the second end are arranged in close proximity. This allows the same routing path for the at least one magnet wire as when the first end and the second end are coupled to a single connector, thereby reducing the need for changing the routing path of the at least one magnet wire when another conductive member including a single connector is replaced with the conductive member including the first connector and the second connector.

One embodiment may include, in addition to or in place of at least any one of Features 1 through 21,
Feature 22: the at least one magnet wire is a single magnet wire.

In the electric work machine including at least Features 1 through 14 and 22, it is possible to inhibit the first and second ends of the single magnet wire from being offset from each other in the axial direction.

One embodiment may include, in addition to or in place of at least any one of Features 1 through 22,
Feature 23: the at least one magnet wire is two or more but a smaller number of magnetic wires than the coils.

In the electric work machine including at least Features 1 through 14 and 23, it is possible to inhibit the first and second ends of each of the two or more but a smaller number of magnetic wires than the coils from being offset from each other in the axial direction.

One embodiment may include, in addition to or in place of at least any one of Features 1 through 23, at least any one of:
Feature 24: a rotational position sensor configured to detect a rotational position of the rotor; and
Feature 25: the rotational position sensor is arranged on the stator core opposite to the conductive member in the axial direction.

In the electric work machine including at least Features 1 through 14, 24, and 25, it is possible to inhibit the conductive member and the rotational position sensor from interfering with each other while reducing the size of the brushless DC motor in the axial direction.

One embodiment may include, in addition to or in place of at least any one of Features 1 through 25,
Feature 26: the first connector and the second connector overlap the stator core, as viewed from the axial direction.

In the electric work machine including at least Features 1 through 14 and 26, it is possible to reduce a size of the brushless DC motor in the radial direction since the first connector and the second connector are not arranged farther outside of the stator core in the radial direction. This makes it possible to further inhibit increase of the electric work machine in size.

One embodiment may include, in addition to or in place of at least any one of Features 1 through 26,
Feature 27: the conductive member electrically couples different two of the coils to each other.

In the electric work machine including at least Features 1 through 14 and 27, it is possible to dispense with an interconnect wire (or a jumper wire or a bridge wire) for electrically coupling different two coils to each other.

One embodiment may include, in addition to or in place of at least any one of Features 1 through 27,
Feature 28: the coils include a multiple of three coils.

In the electric work machine including at least Features 1 through 14 and 28, the brushless DC motor can be a three-phase brushless DC motor.

One embodiment may include, in addition to or in place of at least any one of Features 1 through 28, at least any one of:
Feature 29: the rotor includes eight magnetic poles; and
Feature 30: the stator includes six slots.

In the electric work machine including at least Features 1 through 14 and 28 through 30, the brushless DC motor can be an eight-pole, six-slot, three-phase brushless motor.

One embodiment may include, in addition to or in place of at least any one of Features 1 through 30,
Feature 31: the conductive member is directly or indirectly in contact with the insulator.

One embodiment may include, in addition to or in place of at least any one of Features 1 through 31,
Feature 32: the conductive member includes a power receiver configured to receive electric power for the coils.

One embodiment may include, in addition to or in place of at least any one of Features 1 through 32,
Feature 33: a housing accommodating the brushless DC motor therein.

One embodiment may provide a method including at least any one of:
Feature 34: stacking a conductive member on a stator core via an insulator in an axial direction of a rotation axis of a brushless DC motor of an electric work machine;
Feature 35: the conductive member includes a first connector and a second connector;
Feature 36: the first connector and the second connector are offset from each other in a circumferential direction of the rotation axis;
Feature 37: the first connector and the second connector are aligned with each other across the axial direction;
Feature 38: coupling (or connecting) a first end of a magnet wire to the first connector;
Feature 39: winding the magnet wire around teeth of the stator core via an insulator to thereby form coils such that the first connector and the second connector overlap an axially extended region of the coils, when viewed from a direction perpendicular to the axial direction; and
Feature 40: coupling (or connecting) a second end of the magnet wire to the second connector.

According to the method including at least Features 34 through 40, it is possible to reduce a size of the brushless DC motor in the axial direction. As a result, the electric work machine can be inhibited from increasing in size.

Examples of the electric work machine include, but are not limited to, various types of equipment configured for use in construction, manufacturing, gardening, civil engineering, and other job-sites, specifically, power tools for stone processing, metal processing, and wood processing; power tools for gardening; power tools for job-site environment; fan vests; fan jackets; electric wheelbarrows (or electric dollies); electric-assisted bicycles; and electric inflators.

Examples of the power tools include, but are not limited to, an electric chainsaw, an electric handheld saw, an electric blower, an electric hammer, an electric hammer drill, an electric drill, an electric screwdriver, an electric wrench, an electric impact driver, an electric impact wrench, an electric grinder, an electric circular saw, an electric reciprocating saw, an electric jigsaw, an electric cutter, an electric planer, an electric nailer (including a tacker), an electric hedge trimmer, an electric lawn mower, an electric grass trimmer, an electric bush cutter, an electric cleaner, an electric sprayer, an electric spreader, an electric dust collector (or an electric dust extractor), an electric trowell, an electric vibrator, an electric rammer, an electric compactor, an electric pump, an electric pile driver, an electric concrete saw, an electric screed, and an electric cut-off saw.

The electric work machine may be battery-operated or battery-powered. Specifically, the electric work machine may have a built-in battery. Alternatively, the electric work machine may be configured such that a battery pack is detachably attached thereto. The battery pack houses a battery therein.

In one embodiment, Features 1 through 40 may be combined in any combination.

In one embodiment, any of Features 1 through 40 may be excluded.

### 2. Specific Example Embodiments

Specific example embodiments will be described hereinafter.

### 2-1. First Embodiment

The present first embodiment provides an electric work machine 1 in the form of an electric impact driver. This electric work machine 1 is merely an example, and the present disclosure can be applied to various types of electric work machines.

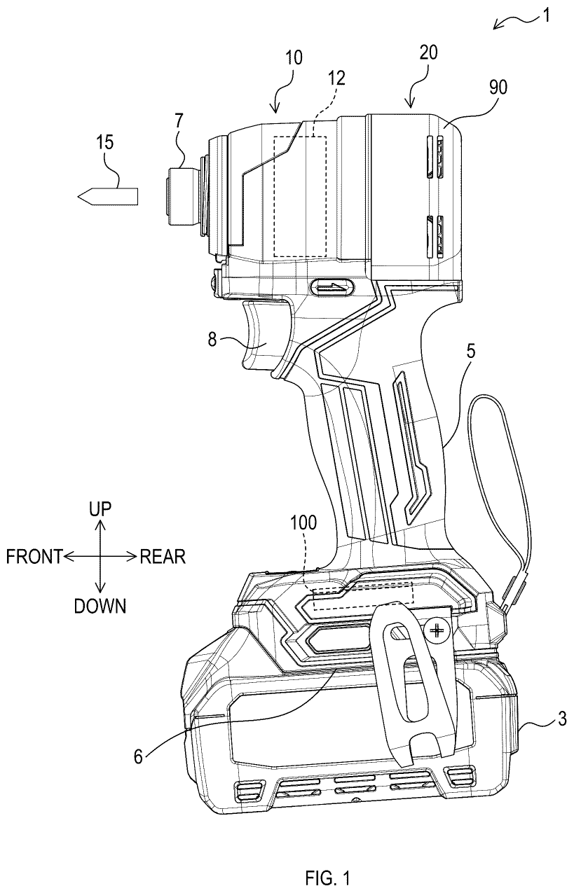

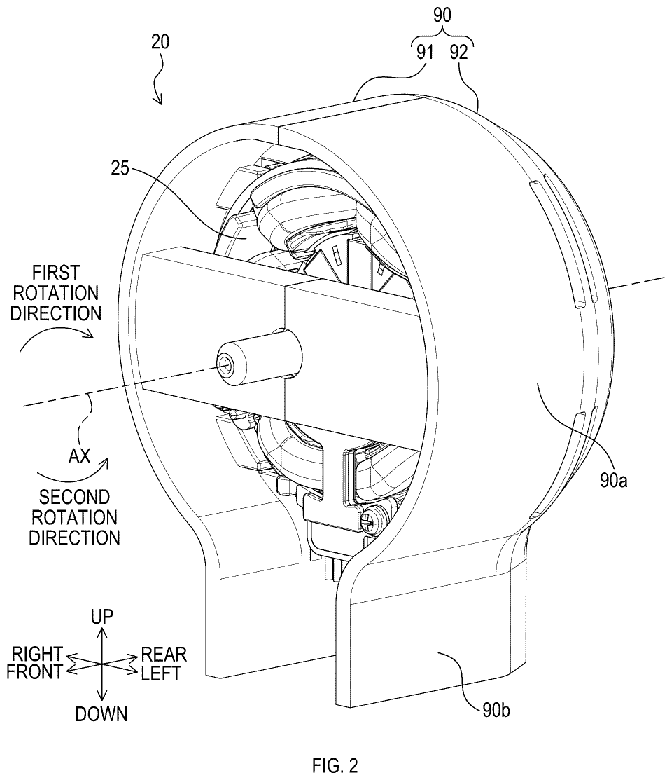

In the following description or the drawings, for convenience of explanation, directions “up,” “down,” “front,” “rear,” “left,” and “right” are defined as shown in FIGS. 1, 2, and so on. However, these directions are only used to facilitate easy understanding of the structure of the electric work machine 1, and are not intended to limit orientation of the electric work machine 1. The electric work machine 1 can be oriented in any direction.

### 2-1-1. Overall Configuration of Electric Work Machine

As shown in FIG. 1, the electric work machine 1 includes a head 10, a motor unit 20, a grip 5, a battery attachment portion 6, a chuck sleeve 7, and a trigger 8. The motor unit 20 is fixed to a rear end of the head 10. The motor unit 20 includes a motor 25 and a housing 90 to be described later. The chuck sleeve 7 is provided at a front end of the head 10.

The grip 5 is located below the head 10 and the motor unit 20, and extends downward. The grip 5 is configured to be gripped by a user of the electric work machine 1. The battery attachment portion 6 is located at a lower end of the grip 5. The battery attachment portion 6 is configured such that the battery pack 3 is detachably attached thereto. The battery pack 3 includes series-connected battery cells, and is rechargeable. Each battery cell is, but not limited to, a lithium ion battery.

The trigger 8 is located at an upper front of the grip 5. The trigger 8 is configured to be manually operated by the user. Specifically, the electric work machine 1 is configured such that the motor 25 rotates in response to the user pulling the trigger 8, and the motor 25 stops in response to the user releasing the trigger 8.

The head 10 houses therein a power transmitter 12. The power transmitter 12 is arranged in front of the motor unit 20, and mechanically coupled to the motor 25.

The chuck sleeve 7 is configured such that a driven tool 15 is detachably attached thereto. In the first embodiment, the driven tool 15 takes the form of various types of tool bits, for example. Examples of the various types of tool bits include, but are not limited to, a driver bit, a socket bit, and a drill bit.

The power transmitter 12 is mechanically coupled to the chuck sleeve 7 to transmit rotation of the motor 25 to the chuck sleeve 7. Thus, when the motor 25 rotates, the chuck sleeve 7 rotates together with the driven tool 15 attached thereto. In addition, the power transmitter 12 includes a striking mechanism (not shown). The striking mechanism applies to the chuck sleeve 7 a striking force in a rotation direction of the chuck sleeve 7 intermittently when a load applied from the chuck sleeve 7 exceeds a specified level. The load is applied in a direction opposite to the rotation direction of the chuck sleeve 7.

The grip 5 includes a controller 100 inside a lower end thereof. The controller 100 receives electric power from the battery pack 3 for operation, and controls the electric work machine 1. For example, the controller 100 controls drive currents supplied from the battery pack 3 to the motor 25 to thereby control driving of the motor 25.

### 2-1-2. Configuration of Motor Unit

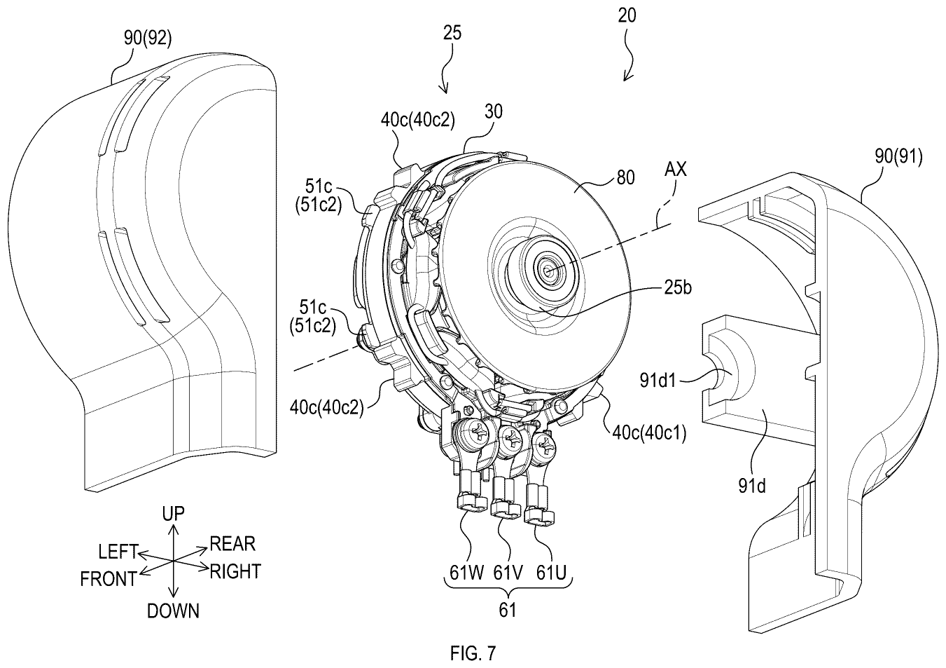

Referring to FIGS. 2 through 13, the motor unit 20 will be described.

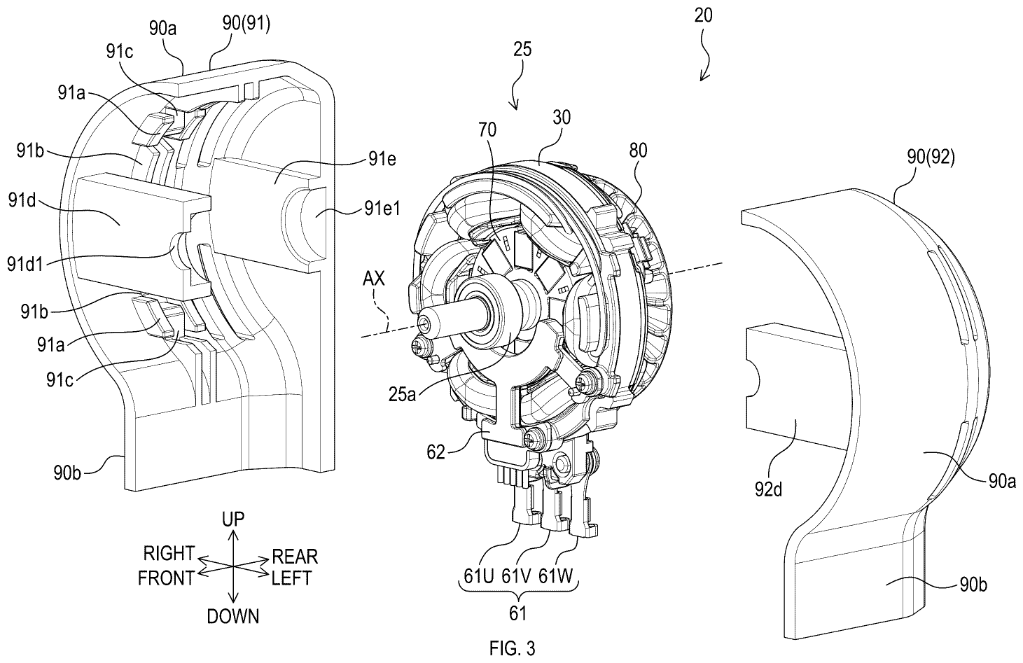

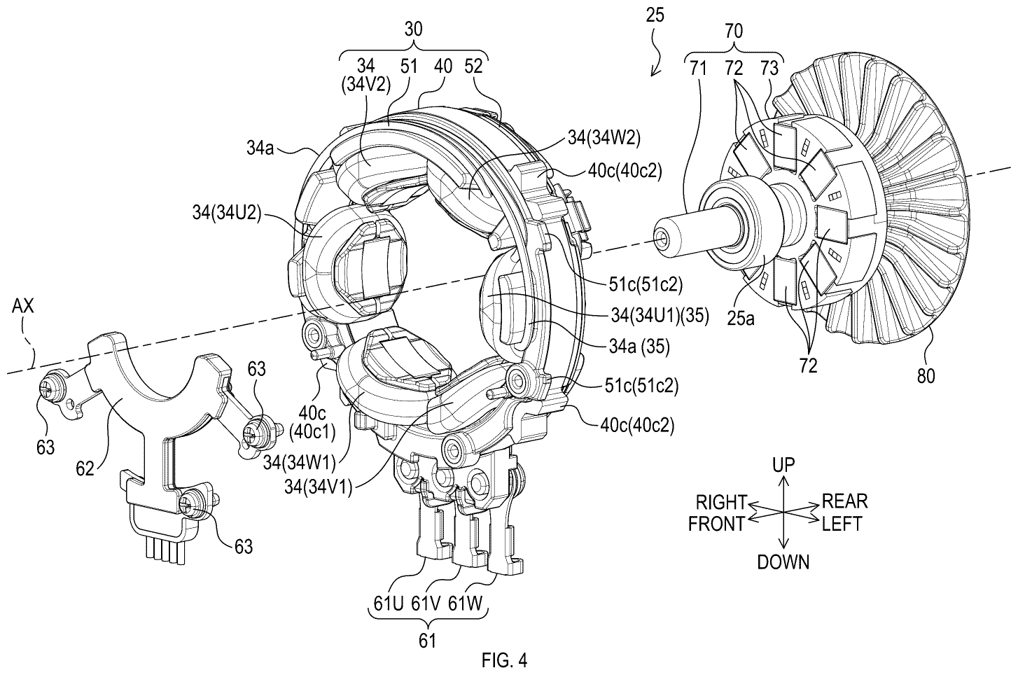

As shown in FIG. 3, the motor unit 20 includes the motor 25, a fan 80, a circuit board 62, and the housing 90. As shown in FIG. 4, the motor 25 includes a rotor 70 and a stator 30. As shown in FIGS. 3, 4, 7 and 8, the motor 25 includes a front bearing 25a and a rear bearing 25b. The front bearing 25a and the rear bearing 25b rotatably support the rotor 70.

The motor 25 of the present first embodiment is in the form of an inner-rotor three-phase brushless DC motor having a multiple of four magnetic poles (including four magnetic poles) and a multiple of three slots (including three slots). As an example combination of such number of poles (that is, number of magnetic poles) and number of slots, a combination of eight poles with six slots is exemplified in the present first embodiment. The motor 25 of the present first embodiment includes a U-phase, V-phase, and W-phase as three phases.

Hereinafter, directions parallel to a rotation axis AX of the motor 25 are referred to as “axial direction”. The axial direction coincides with front-rear directions. In the radial direction of the rotation axis AX, a position close to or a direction approaching the rotation axis AX is referred to as “radially inward”, and a position far from or a direction away from the rotation axis AX is referred to as “radially outward”. In the circumferential direction of the rotation axis AX, a clockwise direction and a counterclockwise direction, when viewed from the front toward the rear, are referred to as “first rotation direction”, and “second rotation direction, respectively.

### 2-1-3. Housing

As shown in FIGS. 2 and 3, the housing 90 is configured to accommodate the motor 25 therein. The housing 90 is an electrical insulating member, and made of resin (for example, synthetic resin).

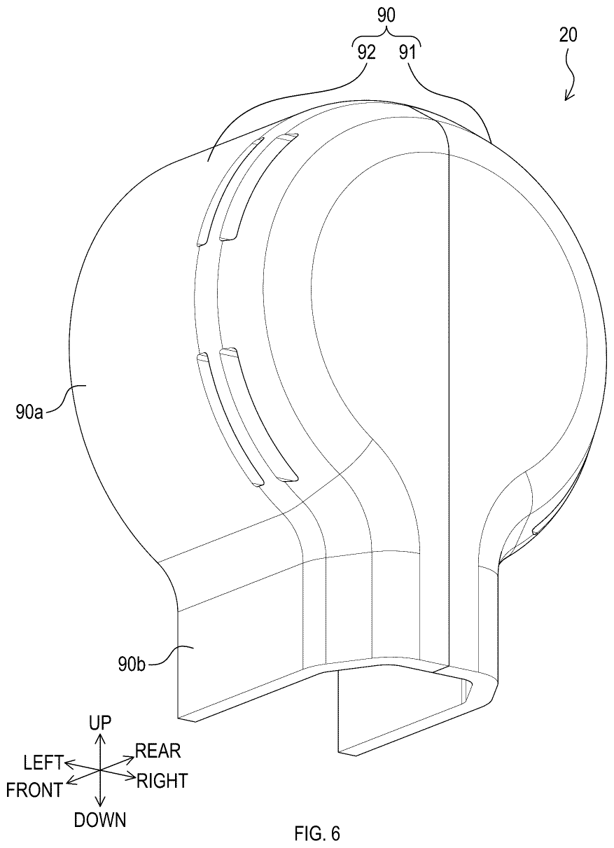

As shown in FIGS. 2 and 6, the housing 90 includes a cylindrical portion 90a and a protruding portion 90b. The cylindrical portion 90a has a cylindrical shape with a front side open and a rear side closed. The protruding portion 90b protrudes downward from a lower side of the cylindrical portion 90a. The protruding portion 90b houses later-described power supply terminals 61.

As shown in FIGS. 2, 3, and 5 through 7, the housing 90 is configured to be separable into a right-partial housing 91 and a left-partial housing 92. The right-partial housing 91 forms a right side part of the housing 90. The left-partial housing 92 forms a left side part of the housing 90. The right-partial housing 91 is assembled from the right side of the motor 25 with respect to the stator 30. The left-partial housing 92 is assembled from the left side of the motor 25 with respect to the stator 30. The left-partial housing 92 is arranged to face the right-partial housing 91 to thereby house the motor 25 between the right-partial housing 91 and the left-partial housing 92.

As shown in FIG. 3, the right-partial housing 91 includes two first protruding portions 91a and a second protruding portion 91b. Each of the first protruding portions 91a protrudes toward the motor 25 from an inner surface of the right-partial housing 91. The second protruding portion 91b protrudes toward the motor 25 from a position on the inner surface of the right-partial housing 91 that differs from both of the first protruding portions 91a in the circumferential direction of the rotation axis AX.

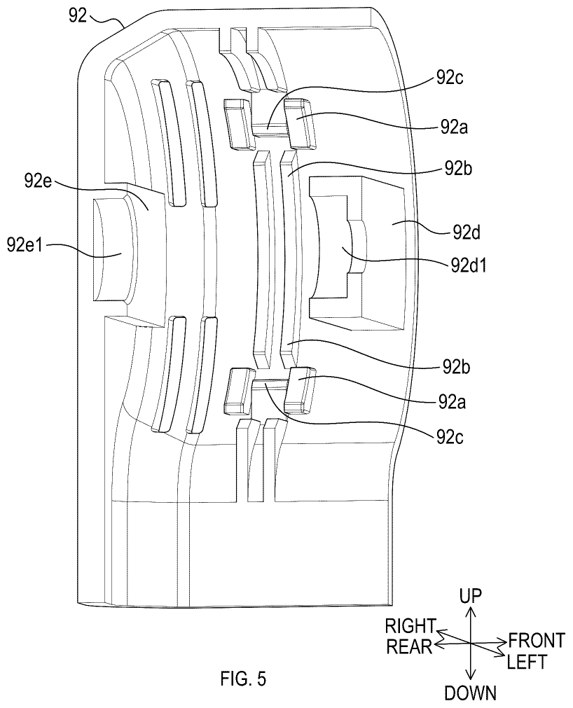

As shown in FIG. 5, the left-partial housing 92 includes two third protruding portions 92a and a fourth protruding portion 92b. Each of the third protruding portions 92a protrudes toward the motor 25 from an inner surface of the left-partial housing 92. The fourth protruding portion 92b protrudes toward the motor 25 from a position on the inner surface of the left-partial housing 92 that differs from both of the third protruding portions 92a in the circumferential direction of the rotation axis AX.

When the right-partial housing 91 and the left-partial housing 92 are arranged to face each other, each of the first protruding portions 91a of the right-partial housing 91 faces a corresponding one of the third protruding portions 92a of the left-partial housing 92 across the motor 25.

In addition, the second protruding portion 91b of the right-partial housing 91 faces the fourth protruding portion 92b of the left-partial housing 92 across the motor 25.

As shown in FIG. 3, the right-partial housing 91 includes two fifth protruding portions 91c. Each of the fifth protruding portions 91c protrudes toward the motor 25 from the inner surface of the right-partial housing 91.

As shown in FIG. 5, the left-partial housing 92 includes two sixth protruding portions 92c. Each of the sixth protruding portions 92c protrudes toward the motor 25 from the inner surface of the left-partial housing 92.

As shown in FIG. 3, the right-partial housing 91 includes a front bearing supporter 91d and a rear bearing supporter 91e. The front bearing supporter 91d protrudes toward the front bearing 25a of the motor 25 from the inner surface of the right-partial housing 91. The front bearing supporter 91d includes a front bearing abutment portion 91d1. The front bearing abutment portion 91d1 is configured to abut on the front bearing 25a. The rear bearing supporter 91e is formed on a rear inner surface of the right-partial housing 91. The rear bearing supporter 91e includes a rear bearing abutment portion 91e1. The rear bearing abutment portion 91e1 is configured to abut on the rear bearing 25b.

As shown in FIG. 5, the left-partial housing 92 includes a front bearing supporter 92d and a rear bearing supporter 92e. The front bearing supporter 92d protrudes toward the front bearing 25a of the motor 25 from the inner surface of the left-partial housing 92. The front bearing supporter 92d includes a front bearing abutment portion 92d1. The front bearing abutment portion 92d1 is configured to abut on the front bearing 25a. The rear bearing supporter 92e is formed on a rear inner surface of the left-partial housing 92. The rear bearing supporter 92e includes a rear bearing abutment portion 92e1. The rear bearing abutment portion 92e1 is configured to abut on the rear bearing 25b.

### 2-1-4. Rotor

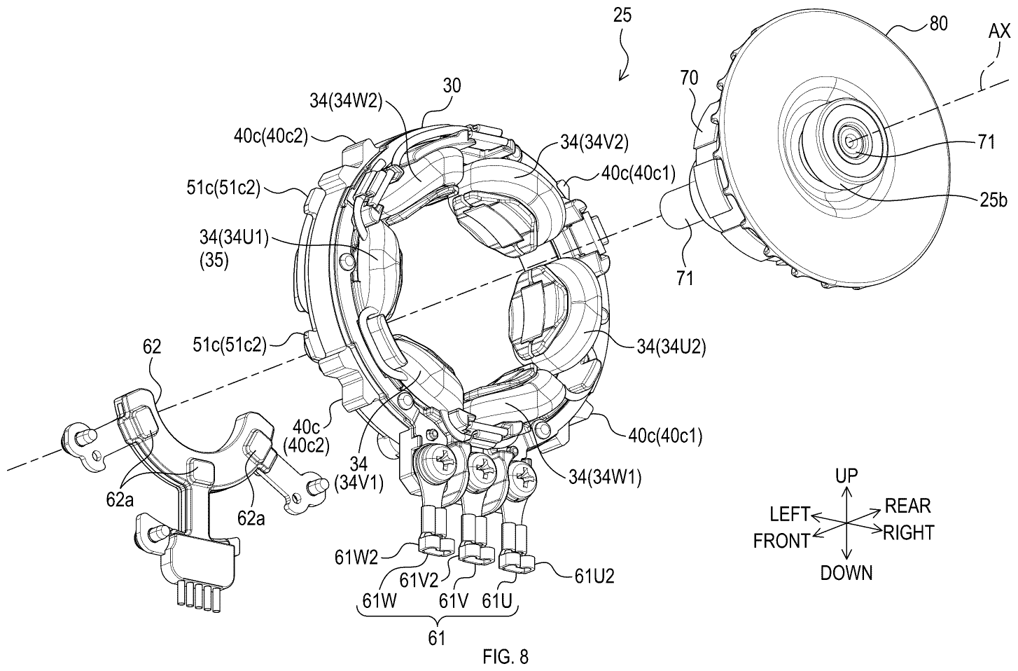

As shown in FIGS. 4 and 8, the rotor 70 includes a rotor shaft 71, magnetic pole portions 72, and a rotor core 73. The rotor 70 rotates about the rotation axis AX.

The rotor core 73 includes laminated steel plates. Each of the steel plates primarily contains iron. The rotor core 73 has an approximately cylindrical shape surrounding the rotation axis AX. The rotor core 73 includes, in its center, a through hole extending from its front surface to its rear surface.

The rotor shaft 71 is inserted in the through hole of the rotor core 73 so as to extend in the axial direction, and is fixed to the rotor core 73. A front part of the rotor shaft 71 protrudes forward from a front end of the rotor core 73, and is rotatably supported by the front bearing 25a. A rear part of the rotor shaft 71 protrudes rearward from a rear end of the rotor core 73, and is rotatably supported by the rear bearing 25b.

The magnetic pole portions 72 are arranged in the rotor core 73 at regular intervals in the circumferential direction of the rotation axis AX. Each of the magnetic pole portions 72 has a permanent magnet embedded in the rotor core 73. Each of the magnetic pole portions 72 extends from a radially inner side to a radially outer side of the rotor core 73. In other words, the magnetic pole portions 72 are arranged in a spoke-like configuration around the rotation axis AX. Each of the magnetic pole portions 72 has a north pole region and a south pole region. The magnetic pole portions 72 are arranged such that the same poles of the adjacent magnetic pole portions 72 along the circumferential direction face each other. In other words, a north pole of one magnetic pole portion 72 faces a north pole of another magnetic pole portion 72 adjacent in the circumferential direction. Also, a south pole of one magnetic pole portion 72 faces a south pole of another magnetic pole portion 72 adjacent in the circumferential direction. In the present first embodiment, the magnetic pole portions 72 include eight magnetic pole portions 72.

As shown in FIGS. 4 and 8, the fan 80 is arranged closer to a rear side of the rotor shaft 71 than the rotor core 73, and is fixed to the rear side of the rotor shaft 71. When the rotor shaft 71 rotates, the fan 80 rotates together with the rotor shaft 71.

### 2-1-5. Stator

As shown in FIGS. 4, 8, and 9, the stator 30 includes a stator core 40, a first insulator 51, a second insulator 52, coils 34, a conductive member 55, three power supply terminals 61, and three fixation screws 59.

The stator core 40 includes steel plates laminated in the axial direction. Each of the steel plates primarily contains iron.

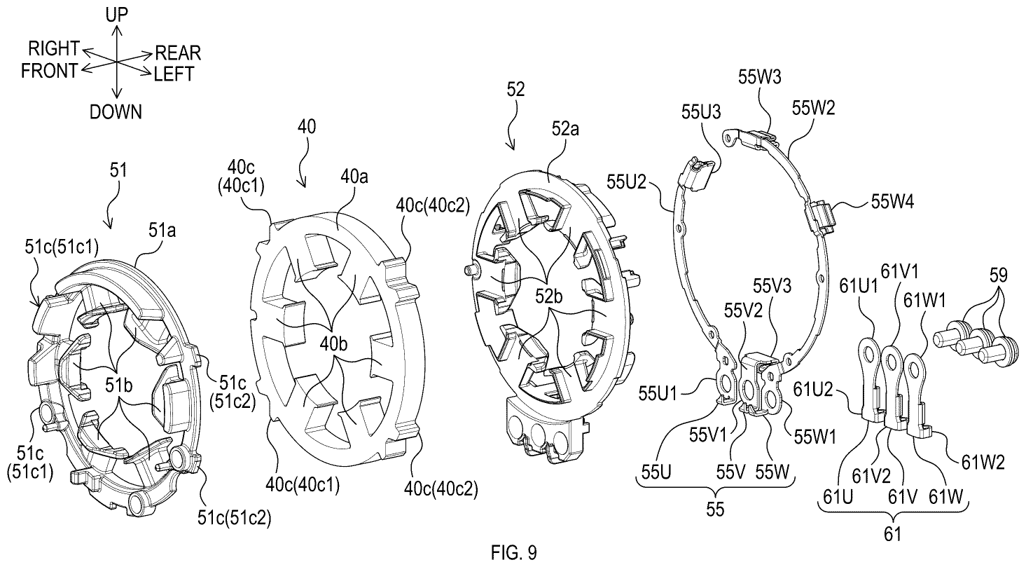

As shown in FIG. 9, the stator core 40 includes a yoke 40a and teeth 40b. The yoke 40a has a cylindrical or annular shape. The yoke 40a is arranged such that its center coincides with the rotation axis AX.

The teeth 40b protrude radially inward (in other words, toward the rotation axis AX) from an inner circumferential surface of the yoke 40a. The teeth 40b are arranged at equal intervals in the circumferential direction. The teeth 40b are integrally formed with the yoke 40a. In the present first embodiment, the teeth 40b have six teeth 40b.

As shown in FIG. 9, the first insulator 51 and the second insulator 52 are separately formed and fixed to the stator core 40. The first insulator 51 and the second insulator 52 are made of synthetic resin but may alternatively be made of another electrical insulating material. The first insulator 51 has a shape that covers a front side of the stator core 40. The second insulator 52 has a shape that covers a rear side of the stator core 40.

In other words, the first insulator 51 is fixed to the stator core 40 at the front side of the stator core 40, and covers a front side surface of the stator core 40. The second insulator 52 is fixed to the stator core 40 at the rear side of the stator core 40, and covers a rear side surface of the stator core 40.

The first insulator 51, the stator core 40, and the second insulator 52 configured as above can be separated from each other.

In another embodiment, the first insulator 51 and the second insulator 52 may be integrally formed to cover the stator core 40.

As shown in FIGS. 4, 8, and 9, the first insulator 51 includes a first main portion 51a and first teeth 51b. The first main portion 51a has a cylindrical or annular shape. The first main portion 51a is arranged such that its center coincides with the rotation axis AX.

The first teeth 51b protrudes radially inward (in other words, toward the rotation axis AX) from an inner circumferential surface of the first main portion 51a. In the present first embodiment, the first teeth 51b have six first teeth 51b. Each of the first teeth 51b is configured to cover a front side surface of a corresponding one of the teeth 40b of the stator core 40.

As shown in FIGS. 4, 8, and 9, the second insulator 52 includes a second main portion 52a and second teeth 52b. The second main portion 52a has a cylindrical or annular shape. The second main portion 52a is arranged such that its center coincides with the rotation axis AX.

The second teeth 52b protrude radially inward (in other words, toward the rotation axis AX) from an inner circumferential surface of the second main portion 52a. In the present first embodiment, the second teeth 52b have six second teeth 52b. Each of the second teeth 52b is configured to cover a rear side surface of a corresponding one of the teeth 40b of the stator core 40.

Each stator teeth is formed from a corresponding one of the teeth 40b, a corresponding one of the first teeth 51b, and a corresponding one of the second teeth 52b. In other words, the stator 30 of the present first embodiment includes six stator teeth.

The stator 30 includes a multiple of three slots (including three slots). The stator 30 of the present first embodiment includes six stator teeth as an example. Thus, the stator 30 of the present first embodiment includes six slots. Each of the six slots corresponds to a gap between two stator teeth adjacent to each other.

### 2-1-6. Coils

As shown in FIGS. 4 and 8, in the present first embodiment, the coils 34 have six coils 34. Each of the six coils 34 is provided on a corresponding one of the stator teeth. That is, each of the six coils 34 covers a portion of the stator core 40, a portion of the first insulator 51, and a portion of the second insulator 52 in a corresponding one of the stator teeth.

The coils 34 are wound around the teeth 40b of the stator core 40 via the first insulator 51 and the second insulator 52, and connected in series. In detail, each of the coils 34 is wound around a corresponding one of the teeth 40b via a corresponding one of the first teeth 51b and a corresponding one of the second teeth 52b. In other words, each of the six coils 34 is arranged around a corresponding one of the teeth 40b, a corresponding one of the first teeth 51b, and a corresponding one of the second teeth 52b. The six coils 34 and the stator core 40 are electrically insulated from each other by the first insulator 51 and the second insulator 52.

The six coils 34 are formed from a single magnetic wire 35. The coils 34 adjacent to each other in the circumferential direction are coupled by a connection line 34a which is part of the magnetic wire 35. The connection line 34a is positioned between one coil 34 and another coil 34, and is supported by the first insulator 51.

The three power supply terminals 61 are electrically coupled to the battery pack 3 via the controller 100. The battery pack 3 supplies the drive currents to the motor 25 via the controller 100. The controller 100 delivers the drive currents from the battery pack 3 to the motor 25, and excites the stator 30.

As shown in FIGS. 3, 4, and 7 through 9, in the present first embodiment, the power supply terminals 61 include a U-phase power supply terminal 61U, a V-phase power supply terminal 61V, and a W-phase power supply terminal 61W. The U-phase power supply terminal 61U receives a U-phase drive current. The V-phase power supply terminal 61V receives a V-phase drive current. The W-phase power supply terminal 61W receives a W-phase drive current.

As shown in FIGS. 4 and 8, the six coils 34 include three pairs of coils, and each pair of coils is assigned to any one of the U-phase, the V-phase, and the W-phase. In other words, a first pair of coils 34 is assigned to the U-phase, and includes a U-phase coil 34U1 and a U-phase coil 34U2. The U-phase coil 34U1 and the U-phase coil 34U2 are arranged to face each other in the radial direction. A second pair of coils 34 is assigned to the V-phase, and includes a V-phase coil 34V1 and a V-phase coil 34V2. The V-phase coil 34V1 and the V-phase coil 34V2 are arranged to face each other in the radial direction. A third pair of coils 34 is assigned to the W-phase, and includes a W-phase coil 34W1 and a W-phase coil 34W2. The W-phase coil 34W1 and the W-phase coil 34W2 are arranged to face each other in the radial direction.

In detail, in the circumferential direction, the V-phase coil 34V1 is arranged next to the U-phase coil 34U1, and the W-phase coil 34W1 is arranged next to the V-phase coil 34V1. The U-phase coil 34U2 is arranged next to the W-phase coil 34W1, and the V-phase coil 34V2 is arranged next to the U-phase coil 34U2. The W-phase coil 34W2 is arranged next to the V-phase coil 34V2, and the U-phase coil 34U1 is arranged next to the W-phase coil 34W2.

The controller 100 controls the drive currents flowing through the U-phase coil 34U1, the U-phase coil 34U2, the V-phase coil 34V1, the V-phase coil 34V2, the W-phase coil 34W1, and the W-phase coil 34W2 via the U-phase power supply terminal 61U, the V-phase power supply terminal 61V, and the W-phase power supply terminal 61W.

As shown in FIG. 9, the conductive members 55 are arranged on a rear side of the second insulator 52. The conductive members 55 are stacked on the yoke 40a via the second insulator 52 in the axial direction of the rotation axis AX. In other words, the conductive members 55 are electrically insulated from the stator core 40 by the second insulator 52. The conductive members 55 include conductive material.

In other words, the conductive members 55 are stacked on the second insulator 52 directly in contact with the second insulator 52. The conductive members 55 are stacked on the second insulator 52 on a side of the second insulator 52 opposite to a side of the second insulator 52 facing the stator core 40.

In another embodiment, the conductive members 55 may be stacked on the second insulator 52 indirectly in contact with the second insulator 52 (e.g., via another member).

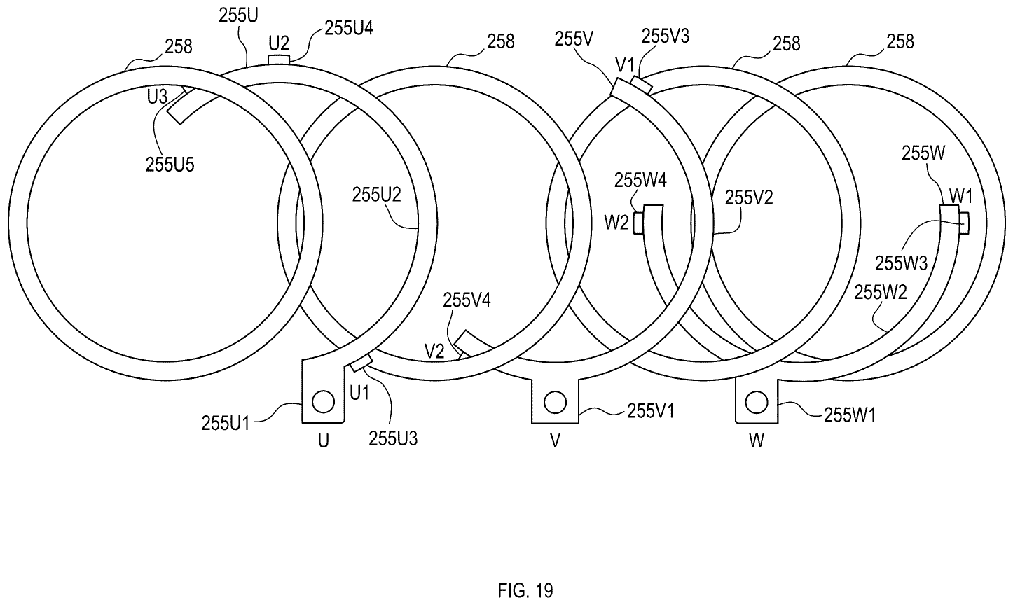

Examples of another member include, but are not limited to, an insulating member 258 (see FIG. 19) to be described later.

The conductive members 55 include the same number of conductive members as the number of phases of the motor 25. In the present first embodiment, the conductive members 55 include a U-phase conductive member 55U, a V-phase conductive member 55V, and a W-phase conductive member 55W.

The U-phase conductive member 55U, the V-phase conductive member 55V, and the W-phase conductive member 55W are arranged on a rear side of the yoke 40a of the stator core 40 via the second insulator 52. The U-phase conductive member 55U, the V-phase conductive member 55V, and the W-phase conductive member 55W are each shaped to conform to a part of the annular portion of the yoke 40a.

The U-phase conductive member 55U includes a U-phase fixing hole portion 55U1, a U-phase extension 55U2 and a U-phase fusing terminal 55U3. The U-phase fixing hole portion 55U1 has a hole through which a fixation screw 59 can be inserted. The U-phase extension 55U2 is shaped to conform to a part of the annular portion of the yoke 40a. The U-phase extension 55U2 electrically couples the U-phase fixing hole portion 55U1 to the U-phase fusing terminal 55U3. The U-phase fusing terminal 55U3 is joined, through a fusing process, to the magnet wire 35 (not shown in FIG. 9) which forms the coils 34 and the connection lines 34a. The U-phase fusing terminal 55U3 is electrically coupled to the coils 34 and the connection lines 34a.

The fusing process is a method to thermally bond (or diffusion bond) a magnet wire to a fusing terminal using electrical resistance. The fusing process can, by applying pressure while heating, remove a portion of an insulating coating of the magnetic wire and, at the same time, crimp the magnetic wire to the fusing terminal. The fusing terminal may be a crimp terminal. The magnet wire may have an insulating coating.

The V-phase conductive member 55V includes a V-phase fixing hole portion 55V1, a V-phase extension 55V2, and a V-phase fusing terminal 55V3. The V-phase fixing hole portion 55V1 has a hole through which the fixation screw 59 can be inserted. The V-phase extension 55V2 is shaped to conform to a part of the annular portion of the yoke 40a. The V-phase extension 55V2 electrically couples the V-phase fixing hole portion 55V1 to the V-phase fusing terminal 55V3. The V-phase fusing terminal 55V3 is joined, through the fusing process, to the magnet wire 35 (not shown in FIG. 9) which forms the coils 34 and the connection lines 34a. The V-phase fusing terminal 55V3 is electrically coupled to the coils 34 and the connection lines 34a.

The W-phase conductive member 55W includes a W-phase fixing hole portion 55W1, a W-phase extension 55W2, a first W-phase fusing terminal 55W3, and a second W-phase fusing terminal 55W4. The W-phase fixing hole portion 55W1 has a hole through which the fixation screw 59 can be inserted. The W-phase extension 55W2 is shaped to conform to a part of the annular portion of the yoke 40a. The W-phase extension 55W2 electrically couples the W-phase fixing hole portion 55W1 to the first W-phase fusing terminal 55W3 and the second W-phase fusing terminal 55W4. Each of the first W-phase fusing terminal 55W3 and the second W-phase fusing terminal 55W4 is joined, through the fusing process, to the magnet wire 35 (not shown in FIG. 9) which forms the coils 34 and the connection lines 34a. Each of the first W-phase fusing terminal 55W3 and the second W-phase fusing terminal 55W4 is electrically coupled to the coils 34 and the connection lines 34a.

The U-phase power supply terminal 61U includes a U-phase fixing hole portion 6U1 and a U-phase crimping portion 61U2. The U-phase fixing hole portion 61U1 has a hole through which the fixation screw 59 can be inserted. The U-phase crimping portion 61U2 is configured to be crimped to a U-phase power wiring (not shown). The U-phase power wiring electrically couples the U-phase power supply terminal 61W to the battery pack 3 via the controller 100.

The V-phase power supply terminal 61V includes a V-phase fixing hole portion 61V1 and a V-phase crimping portion 61V2. The V-phase fixing hole portion 61V1 has a hole through which the fixation screw 59 can be inserted. The V-phase crimping portion 61V2 is configured to be crimped to a V-phase power wiring (not shown). The V-phase power wiring electrically couples the V-phase power supply terminal 61V to the battery pack 3 via the controller 100.

The W-phase power supply terminal 61W includes a W-phase fixing hole portion 61W1 and a W-phase crimping portion 61W2. The W-phase fixing hole portion 61W1 has a hole through which the fixation screw 59 can be inserted. The W-phase crimping portion 61W2 is configured to be crimped to a W-phase power wiring (not shown). The W-phase power wiring electrically couples the W-phase power supply terminal 61W to the battery pack 3 via the controller 100.

The three fixation screws 59 fix the U-phase conductive member 55U, the V-phase conductive member 55V, the W-phase conductive member 55W, the U-phase power supply terminal 61U, the V-phase power supply terminal 61V, and the W-phase power supply terminal 61W to the second insulator 52. With the three fixation screws 59, the U-phase conductive member 55U is electrically coupled to the U-phase power supply terminal 61U, the V-phase conductive member 55V is electrically coupled to the V-phase power supply terminal 61V, and the W-phase conductive member 55W is electrically coupled to the W-phase power supply terminal 61W.

### 2-1-7. Circuit Board

As shown in FIGS. 3, 4, and 8, the circuit board 62 is arranged on a front side of the first insulator 51. The circuit board 62 is fixed to the first insulator 51 by a screw 63.

As shown in FIG. 8, three Hall effect sensors 62a corresponding respectively to the U-phase, the V-phase, and the W-phase are mounted on a rear surface of the circuit board 62. The three Hall effect sensors 62a output detection signals to the controller 100 via signal lines (not shown). The controller 100 controls the drive currents delivered to the six coils 34 based on the detection signals received from the three Hall effect sensors 62a.

### 2-1-8. Abutment Portions of Stator Core and First Insulator

As shown in FIGS. 4 and 7 through 9, the yoke 40a of the stator core 40 includes abutment portions 40c. The abutment portions 40c are arranged at specified intervals on an outer circumferential surface of the yoke 40a. The abutment portions 40c protrude outward from the yoke 40a. The abutment portions 40c include two first abutment portions 40c1 and two third abutment portions 40c2. The two first abutment portions 40c1 are arranged in a right side region of the outer circumferential surface of the yoke 40a. The two third abutment portions 40c2 are arranged in a left side region of the outer circumferential surface of the yoke 40a.

As shown in FIGS. 4, 8, and 9, the first main portion 51a of the first insulator 51 includes abutment portions 51c. The abutment portions 51c are arranged at specified intervals on an outer circumferential surface of the first main portion 51a. The abutment portions 51c include two second abutment portions 51c1 and two fourth abutment portions 51c2. The two second abutment portions 51c1 are arranged in a right side region of the outer circumferential surface of the first main portion 51a. The two fourth abutment portions 51c2 are arranged on a left side region of the outer circumferential surface of the first main portion 51a.

Each of the two second abutment portions 51c1 protrudes radially outward on the outer circumferential surface of the first main portion 51a. Each of the two fourth abutment portions 51c2 protrudes radially outward on the outer circumferential surface of the first main portion 51a.

### 2-1-9. Fixing of Motor to Housing

Referring to FIGS. 2 through 9, fixing of the motor 25 (the stator 30 and the rotor 70, in detail) to the housing 90 (the right-partial housing 91 and the left-partial housing 92, in detail) will be described.

By assembling the right-partial housing 91 onto the motor 25 from the right side, and further assembling the left-partial housing 92 onto the motor 25 from the left side, the motor 25 is fixed between the right-partial housing 91 and the left-partial housing 92. At this point in time, the stator 30 and the rotor 70 of the motor 25 are separately fixed to the housing 90.

The stator 30 is assembled onto the right-partial housing 91 with each of the two first abutment portions 40c1 being in contact with or close to a corresponding one of the two first protruding portions 91a and each of the two second abutment portions 51c1 being in contact with or close to the second protruding portion 91b. The stator 30 is assembled onto the left-partial housing 92 with each of the two third abutment portions 40c2 being in contact with or close to a corresponding one of the two third protruding portions 92a and each of the two fourth abutment portions 51c2 being in contact with or close to the fourth protruding portion 92b.

When at least one of the two first abutment portions 40c1 abuts on the corresponding one of the two first protruding portions 91a or at least one of the two third abutment portions 40c2 abuts on the corresponding one of the two third protruding portions 92a, the stator 30 is restrained from moving forward inside the housing 90.

When at least one of the two second abutment portions 51c1 abuts on the second protruding portion 91b or at least one of the two fourth abutment portions 51c2 abuts on the fourth protruding portion 92b, the stator 30 is restrained from moving rearward inside the housing 90.

The stator 30 is assembled onto the right-partial housing 91 with each of the two first abutment portions 40c1 being in contact with or close to a corresponding one of the two fifth protruding portions 91c. The stator 30 is assembled onto the left-partial housing 92 with each of the two third abutment portions 40c2 being in contact with or close to a corresponding one of the two sixth protruding portions 92c.

When at least one of the two first abutment portions 40c1 abuts on the corresponding one of the two fifth protruding portions 91c or at least one of the two third abutment portions 40c2 abuts on the corresponding one of the two sixth protruding portions 92c, the stator 30 is restrained from moving in the circumferential direction inside the housing 90. The circumferential movement restrained at this point in time includes movements in both the first rotation direction and the second rotation direction (see FIG. 2).

This maintains the stator 30 in a constant axial and circumferential position relative to the housing 90.

The rotor 70 is assembled onto the housing 90 with the front bearing 25a being in contact with the front bearing abutment portion 91d1 of the front bearing supporter 91d and the front bearing abutment portion 92d1 of the front bearing supporter 92d, and the rear bearing 25b being in contact with the rear bearing abutment portion 91e1 of the rear bearing supporter 91e and the rear bearing abutment portion 92e1 of the rear bearing supporter 92e.

### 2-1-10. Connection Structure between Coils and Conductive Members

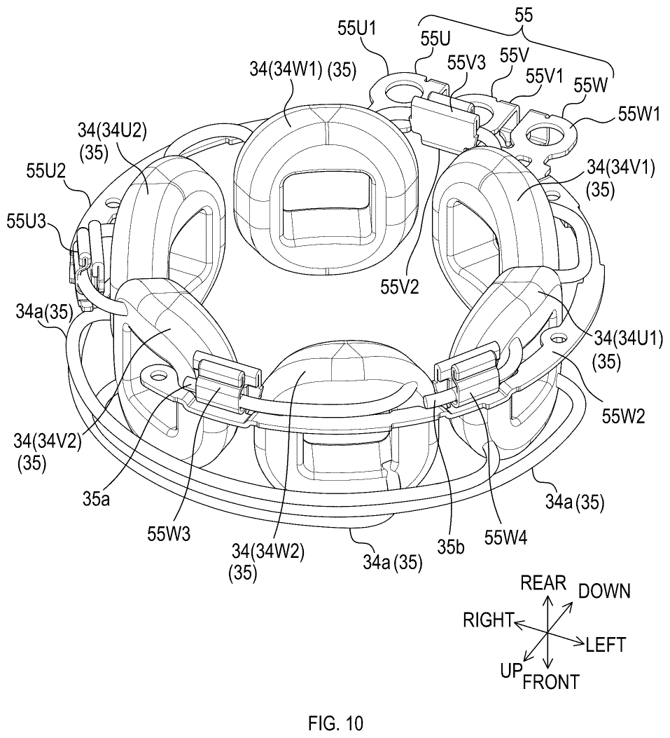

As shown in FIGS. 10, 12, and 13, the magnet wire 35 forming the six coils 34 includes a first end 35a and a second end 35b.

The first end 35a is coupled (or connected) to the first W-phase fusing terminal 55W3 of the W-phase conductive member 55W. The second end 35b is coupled (or connected) to the second W-phase fusing terminal 55W4 of the W-phase conductive member 55W.

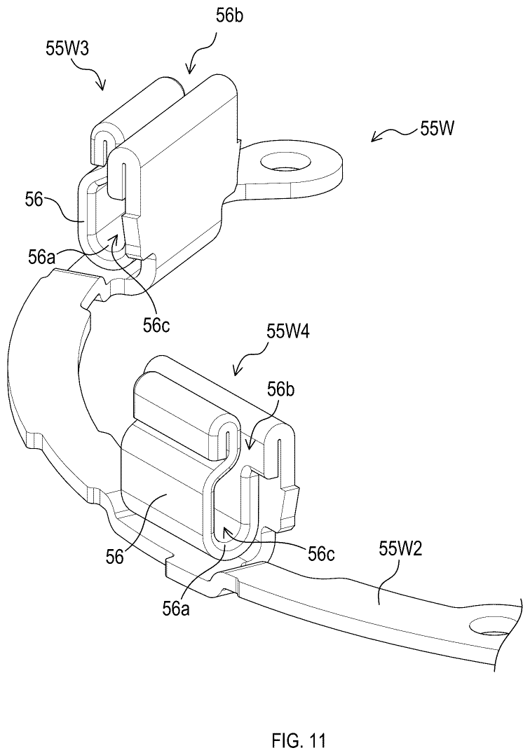

As shown in FIG. 11, the first W-phase fusing terminal 55W3 is formed of a plate member 56 that is bent such that its cross section has a U-shape. The plate member 56 includes a closed end 56a of the U-shape and an open end 56b of the U-shape. The first W-phase fusing terminal 55W3 is arranged such that a first extension direction connecting the closed end 56a and the open end 56b is parallel to the axial direction of the rotation axis AX.

The first W-phase fusing terminal 55W3 is coupled (or connected) to the first end 35a arranged in an inside 56c of the U-shape of the plate member 56. In detail, the first W-phase fusing terminal 55W3 and the first end 35a are electrically coupled to each other through the fusing process.

Similar to the first W-phase fusing terminal 55W3, the second W-phase fusing terminal 55W4 is formed of the plate member 56 that is bent such that its cross section has a U-shape. Similar to the first W-phase fusing terminal 55W3, the second W-phase fusing terminal 55W4 is arranged such that the first extension direction connecting the closed end 56a and the open end 56b is parallel to the axial direction of the rotation axis AX.

The second W-phase fusing terminal 55W4 is coupled (or connected) to the second end 35b arranged in the inside 56c of the U-shape of the plate member 56. In detail, the second W-phase fusing terminal 55W4 and the second end 35b are electrically coupled to each other through the fusing process.

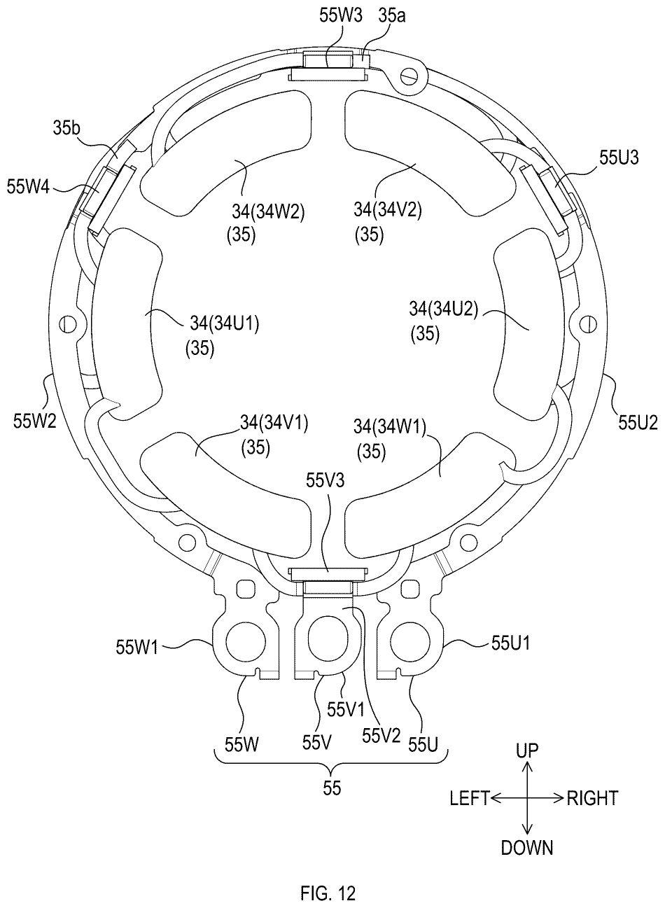

As shown in FIGS. 10 and 12, the first W-phase fusing terminal 55W3 and the second W-phase fusing terminal 55W4 are arranged at different positions (or offset from each other) in the circumferential direction along the annular portion of the yoke 40a (in other words, the circumferential direction of the rotation axis AX).

Specifically, the first W-phase fusing terminal 55W3 is arranged such that one of the teeth 40b is situated between the first W-phase fusing terminal 55W3 and the second W-phase fusing terminal 55W4 in the circumferential direction along the annular portion of the yoke 40a. In other words, a gap between the first W-phase fusing terminal 55W3 and the second W-phase fusing terminal 55W4 in the circumferential direction is larger than or equal to a width of one of the teeth 40b in the circumferential direction. The one of teeth 40b here corresponds to the W-phase coil 34W2. Thus, in other words, the first W-phase fusing terminal 55W3 is arranged such that the W-phase coil 34W2 is situated between the first W-phase fusing terminal 55W3 and the second W-phase fusing terminal 55W4 in the circumferential direction along the annular portion of the yoke 40a.

As shown in FIG. 10, the first end 35a (or the first W-phase fusing terminal 55W3) is aligned with the second end 35b (or the second W-phase fusing terminal 55W4) across the axial direction of the rotation axis AX (i.e., in “up-down direction” indicated by arrows in the figure).

In addition, each of the first end 35a and the second end 35b (or each of the first W-phase fusing terminal 55W3 and the second W-phase fusing terminal 55W4) overlaps an axially extended region of the coils 34, when viewed from a direction perpendicular to the rotation axis AX.

In the stator 30 configured as above, the first end 35a and the second end 35b are not offset from each other in the axial direction of the rotation axis AX.

In addition, in the stator 30, one of the teeth 40b is situated between the first W-phase fusing terminal 55W3 and the second W-phase fusing terminal 55W4 in the circumferential direction along the annular portion of the yoke 40a. Thus, it is possible to ensure a certain spacing or more between the first W-phase fusing terminal 55W3 and the second W-phase fusing terminal 55W4.

The V-phase fusing terminal 55V3 and the U-phase fusing terminal 55U3 are also each formed of the plate member 56 which is bent such that its cross section has a U-shape, similar to the first W-phase fusing terminal 55W3.

### 2-1-11. Electrical Connection between Coils and Conductive Member

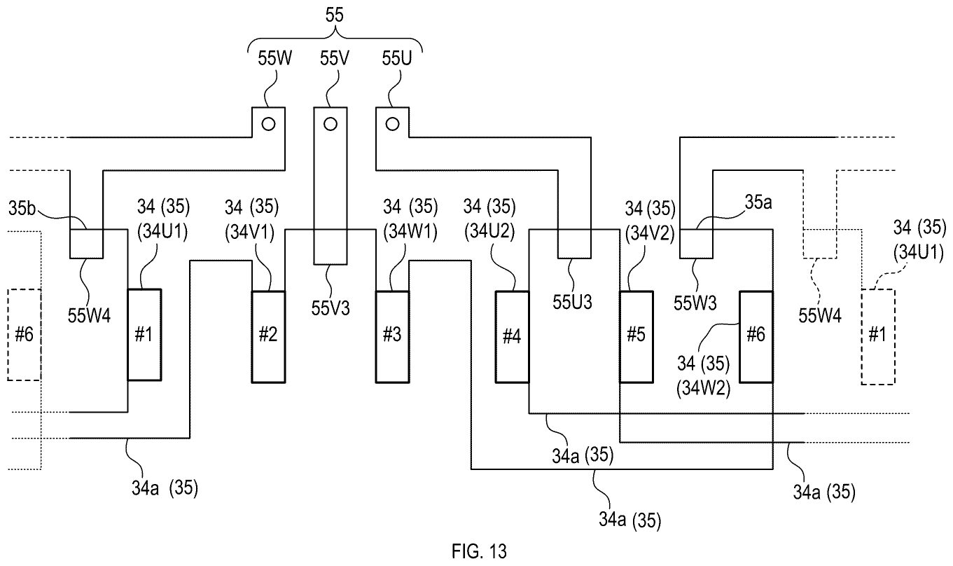

As schematically shown in FIG. 13, the single wire 35 forming the coils 34 is arranged, starting from the second end 35b, in the order of a U-phase coil 34U1 (#1), a U-phase coil 34U2 (#4), a V-phase coil 34V2 (#5), a V-phase coil 34V1 (#2), a W-phase coil 34W1 (#3), and a W-phase coil 34W2 (#6), to reach the first end 35a.

In FIG. 13, the coils 34, the magnet wire 35, and the conductive members 55 are shown with an upper side of the figure as a rear side of the electric work machine 1 and a lower side of the figure as a front side of the electric work machine 1. In other words, in FIG. 13, portions of the magnet wire 35 shown below the coils 34 are the connection lines 34a that are arranged closer to the front side than the coils 34.

A portion of the magnet wire 35 provided between the V-phase coil 34V1 (#2) and the W-phase coil 34W1 (#3) is coupled to the V-phase fusing terminal 55V3. A portion of the magnet wire 35 provided between the U-phase coil 34U2 (#4) and the V-phase coil 34V2 (#5) is coupled to the U-phase fusing terminal 55U3.

### 2-1-12. Process of Coupling Conductive Members to Coils

A process of coupling the conductive members 55 to the coils 34 (in other words, the magnet wire 35) will be described.

First, the conductive members 55 (i.e., the U-phase conductive member 55U, the V-phase conductive member 55V, and the W-phase conductive member 55W) are arranged with respect to the first insulator 51, the stator core 40, and the second insulator 52 assembled together. In detail, the conductive members 55 are stacked on the yoke 40a via the second insulator 52 in the axial direction of the rotation axis AX.

The first W-phase fusing terminal 55W3 is arranged at a different position from the second W-phase fusing terminal 55W4 in the circumferential direction along the annular portion of the yoke 40a (in other words, the circumferential direction of the rotation axis AX).

In addition, the first W-phase fusing terminal 55W3 is aligned with the second W-phase fusing terminal 55W4 across the axial direction of the rotation axis AX.

Next, the magnet wire 35 is wound around the stator teeth (i.e., the teeth 40b, the first teeth 51b, and the second teeth 52b) to form the coils 34. At this point in time, the magnet wire 35 is inserted through the U-phase fusing terminal 55U3 and the V-phase fusing terminal 55V3, in the middle of winding the magnet wire 35.

Next, a task of coupling the first W-phase fusing terminal 55W3 to the first end 35a, and a task of coupling the second W-phase fusing terminal 55W4 to the second end 35b are performed. First, the first end 35a and the second end 35b are inserted respectively through the first W-phase fusing terminal 55W3 and the second W-phase fusing terminal 55W4. After insertions, the fusing processes are performed to complete the task of coupling the first W-phase fusing terminal 55W3 to the first end 35aand the task of coupling the second W-phase fusing terminal 55W4 to the second end 35b.

At this point in time, the first end 35a and the second end 35b overlap the axially extended region of the coils 34, when viewed from the direction perpendicular to the axial direction of the rotation axis AX.

The task of coupling the first W-phase fusing terminal 55W3 to the first end 35a and the task of coupling the second W-phase fusing terminal 55W4 to the second end 35b may be performed in either order. The fusing processes may be performed together with a task of coupling the U-phase fusing terminal 553 to the magnet wire 35 and a task of coupling the V-phase fusing terminal 55V3 to the magnet wire 35.

Consequently, the process of coupling the conductive members 55 to the coils 34 (in other words, the magnet wire 35) is completed.

### 2-1-13. Effects

The first embodiment described above achieves the following effects.
(1) As described above, in the stator 30, the first end 35a is aligned with the second end 35b across the axial direction of the rotation axis AX.

Thus, the dimension of the motor 25 in the axial direction can be reduced, compared to one with the first end 35a and the second end 35b offset from each other in the axial direction of the rotation axis AX.

Therefore, the electric work machine 1 can be inhibited from increasing in size.
(2) In the stator 30, one of the teeth 40b is situated between the first W-phase fusing terminal 55W3 and the second W-phase fusing terminal 55W4 in the circumferential direction along the annular portion of the yoke 40a. Thus, it is possible to ensure a certain spacing or more between the first W-phase fusing terminal 55W3 and the second W-phase fusing terminal 55W4.

Thus, in the electric work machine 1, it can be easy to ensure a work area for coupling the first W-phase fusing terminal 55W3 to the first end 35a and a work area for coupling the second W-phase fusing terminal 55W4 to the second end 35b. As a result, it is possible to reduce complexity of coupling the first end 35a and the second end 35b respectively to the first W-phase fusing terminal 55W3 and the second W-phase fusing terminal 55W4.
(3) In the electric work machine 1, the Hall effect sensors 62a and the conductive members 55 are arranged such that the stator core 40 is interposed therebetween. In detail, the conductive members 55, the stator core 40, and the Hall effect sensors 62a are arranged in this order from the rear side to the front side in the axial direction of the rotation axis AX.

In other words, the Hall effect sensors 62a and the conductive members 55 are arranged opposite to each other with the stator core 40 therebetween in the axial direction of the rotation axis AX.

Therefore, in the electric work machine 1, it is possible to inhibit the conductive members 55 and the Hall effect sensors 62a from interfering with each other, and to inhibit increasing the dimension of the motor 25 in the axial direction.
(4) The first W-phase fusing terminal 55W3 and the second W-phase fusing terminal 55W4 overlap the stator core 40, when viewed from the axial direction of the rotation axis AX. In such a configuration, the first W-phase fusing terminal 55W3 and the second W-phase fusing terminal 55W4 can be inhibited from being disposed radially outward of the stator core 40.

Since the dimension of the motor 25 in the direction perpendicular to the axial direction (in other words, the radial direction of the rotation axis AX) can be reduced in the electric work machine 1, it is possible to inhibit increasing in size of the electric work machine 1.

### 2-1-14. Correspondence between Terms

The motor 25 corresponds to an example of the brushless DC motor in Overview of Embodiments.

The first W-phase fusing terminal 55W3 corresponds to an example of the first connector in Overview of Embodiments. The second W-phase fusing terminal 55W4 corresponds to an example of the second connector in Overview of Embodiments. The U-phase fixing hole portion 55U1, the V-phase fixing hole portion 55V1, and the W-phase fixing hole portion 55W1 correspond to an example of the power receiver in Overview of Embodiments.

The Hall effect sensors 62a correspond to an example of the rotational position sensor in Overview of Embodiments.

### 2-2. Second Embodiment

### 2-2-1. Differences from First Embodiment

The second embodiment has a basic configuration similar to that of the first embodiment, and the following describes the differences from the first embodiment. The same reference numerals as those in the first embodiment indicate the same components, and references are made to the preceding descriptions.

A second electric work machine 101 of the second embodiment differs from the electric work machine 1 of the first embodiment in that the second electric work machine 101 includes second conductive members 155 in place of the conductive members 55.

### 2-2-2. Second Conductive Members

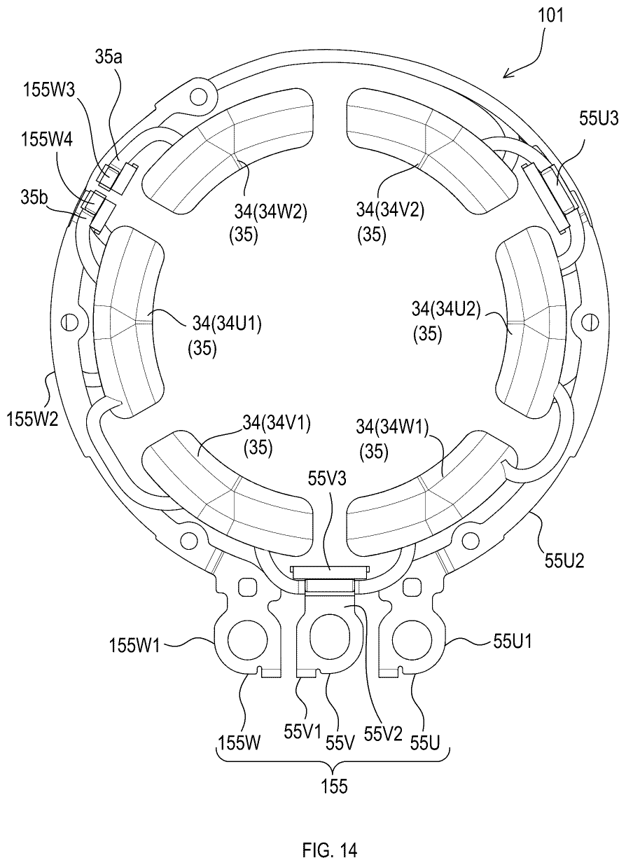

As shown in FIGS. 14 through 16, the second conductive members 155 differs from the conductive members 55 in that the second conductive members 155 includes a second W-phase conductive member 155W in place of the W-phase conductive member 55W. In other words, the second conductive members 155 include the U-phase conductive member 55U, the V-phase conductive member 55V, and the second W-phase conductive member 155W.

The second W-phase conductive member 155W is arranged on the rear side of the yoke 40a of the stator core 40 via the second insulator 52. The second W-phase conductive member 155W is shaped to conform to a part of the annular portion of the yoke 40a.

The second W-phase conductive member 155W includes a second W-phase fixing hole portion 155W1, a second W-phase extension 155W2, a third W-phase fusing terminal 155W3, and a fourth W-phase fusing terminal 155W4. The second W-phase fixing hole portion 155W1 has a hole through which the fixation screw 59 can be inserted. The second W-phase extension 155W2 is shaped to conform to a part of the annular portion of the yoke 40a. The second W-phase extension 155W2 electrically couples the second W-phase fixing hole portion 155W1 to the third W-phase fusing terminal 155W3 and the fourth W-phase fusing terminal 155W4. The third W-phase fusing terminal 155W3 and the fourth W-phase fusing terminal 155W4 are coupled to the magnet wire 35 through the fusing processes. The third W-phase fusing terminal 155W3 and the fourth W-phase fusing terminal 155W4 are electrically coupled to the coils 34 and the connection lines 34a.

### 2-2-3. Connection Structure of Coils and Conductive Members

As shown in FIG. 14, the first end 35a of the magnet wire 35 is coupled to the third W-phase fusing terminal 155W3 of the second W-phase conductive member 155W. The second end 35b is coupled to the fourth W-phase fusing terminal 155W4 of the second W-phase conductive member 155W.

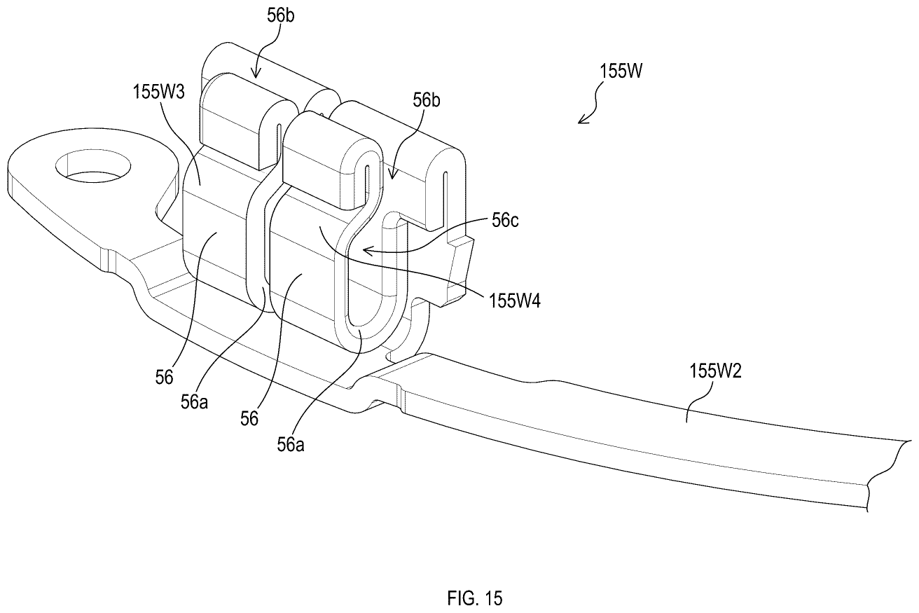

As shown in FIG. 15, the third W-phase fusing terminal 155W3 is formed of the plate member 56 that is bent such that its cross section has a U-shape. The plate member 56 includes the closed end 56a of the U-shape and the open end 56b of the U-shape. The third W-phase fusing terminal 155W3 is arranged such that the first extension direction connecting the closed end 56a and the open end 56b is parallel to the axial direction of the rotation axis AX.

The third W-phase fusing terminal 155W3 is coupled to the first end 35a arranged in the inside 56cof the U-shape of the plate member 56. In detail, the third W-phase fusing terminal 155W3 and the first end 35a are electrically coupled to each other through the fusing process.

The fourth W-phase fusing terminal 155W4 is adjacent to the third W-phase fusing terminal 155W3. Similar to the third W-phase fusing terminal 155W3, the fourth W-phase fusing terminal 155W4 is formed of the plate member 56 that is bent such that its cross section has a U-shape. Similar to the third W-phase fusing terminal 155W3, the fourth W-phase fusing terminal 155W4 is arranged such that the first extension direction connecting the closed end 56a and the open end 56b is parallel to the axial direction of the rotation axis AX.

The fourth W-phase fusing terminal 155W4 is coupled to the second end 35b arranged in the inside 56c of the U-shape of the plate member 56. In detail, the fourth W-phase fusing terminal 155W4 and the second end 35b are electrically coupled to each other through the fusing process.

As shown in FIG. 14, the third W-phase fusing terminal 155W3 is offset from the fourth W-phase fusing terminal 155W4 in the circumferential direction along the annular portion of the yoke 40a (in other words, in the circumferential direction of the rotation axis AX). Specifically, the third W-phase fusing terminal 155W3 is adjacent to the fourth W-phase fusing terminal 155W4 in the circumferential direction along the annular portion of the yoke 40a.

The third W-phase fusing terminal 155W3 and the fourth W-phase fusing terminal 155W4 are arranged between two of the teeth 40b adjacent in the circumferential direction along the annular portion of the yoke 40a. The adjacent two teeth 40b are one of the teeth 40b corresponding to the U-phase coil 34U1 and another one of the teeth 40b corresponding to the W-phase coil 34W2. In other words, the third W-phase fusing terminal 155W3 is arranged such that none of the teeth 40b is situated between the third W-phase fusing terminal 155W3 and the fourth W-phase fusing terminal 155W4 in the circumferential direction along the annular portion of the yoke 40a. In other words, a gap between the third W-phase fusing terminal 155W3 and the fourth W-phase fusing terminal 155W4 in the circumferential direction is smaller than a width of one of the teeth 40b in the circumferential direction.

In the present second embodiment, the first end 35a is aligned with the second end 35b across the axial direction of the rotation axis AX (i.e., in the up-down direction in the figure), as in the first embodiment. In addition, the first end 35a and the second end 35b overlap the axially extended region of the coils 34, when viewed from the direction perpendicular to the rotation axis AX.

In the stator 30 including the second W-phase conductive member 155W, the first end 35a and the second end 35b are not offset from each other in the axial direction of the rotation axis AX.

In addition, in the present second embodiment, none of the teeth 40b is situated between the third W-phase fusing terminal 155W3 and the fourth W-phase fusing terminal 155W4 in the circumferential direction along the annular portion of the yoke 40a.

With this configuration, the magnet wire 35 can be routed such that the first end 35a and the second end 35b are positioned in close proximity to each other.

### 2-2-4. Electrical Connection between Coils and Conductive Members

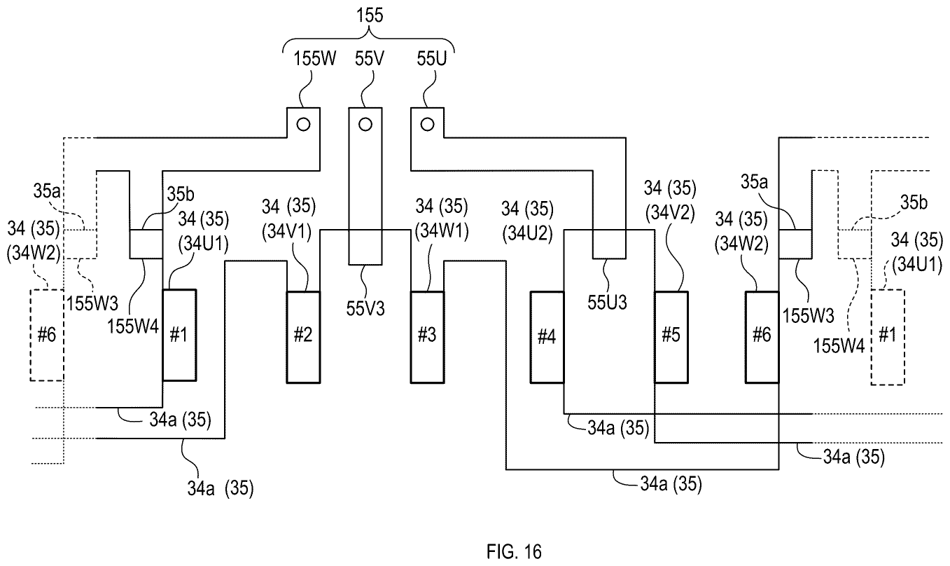

As schematically shown in FIG. 16, the single wire 35 forming the coils 34 are arranged, starting from the second end 35b, in the order of the U-phase coil 34U1 (#1), the U-phase coil 34U2 (#4), the V-phase coil 34V2 (#5), the V-phase coil 34V1 (#2), the W-phase coil 34W1 (#3), and the W-phase coil 34W2 (#6), to reach the first end 35a.

In FIG. 16, the coils 34, the magnet wire 35, and the second conductive members 155 are shown with an upper side of the figure as the rear side of the second electric work machine 101, and a lower side of the figure as the front side of the second electric work machine 101. In other words, in FIG. 16, portions of the magnetic wire 35 shown below the coils 34 are the connection lines 34a that are arranged closer to the front side than the coils 34.

A portion of the magnet wire 35 provided between the V-phase coil 34V1 (#2) and the W-phase coil 34W1 (#3) is coupled to the V-phase fusing terminal 55V3. A portion of the magnet wire 35 provided between the U-phase coil 34U2 (#4) and the V-phase coil 34V2 (#5) is coupled to the U-phase fusing terminal 55U3.

### 2-2-5. Process of Coupling Conductive Members to Coils

A process of coupling the second conductive members 155 to the coils 34 (in other words, the magnet wire 35) will be described.

First, the second conductive members 155 (i.e., the U-phase conductive member 55U, the V-phase conductive member 55V, and the second W-phase conductive member 155W) are arranged with respect to the first insulator 51, the stator core 40, and the second insulator 52 assembled together. In detail, the second conductive members 155 are stacked on the yoke 40a via the second insulator 52 in the axial direction of the rotation axis AX.

The third W-phase fusing terminal 155W3 is offset from the fourth W-phase fusing terminal 155W4 in the circumferential direction along the annular portion of the yoke 40a (in other words, in the circumferential direction of the rotation axis AX).

In addition, the third W-phase fusing terminal 155W3 is aligned with the fourth W-phase fusing terminal 155W4 across the axial direction of the rotation axis AX.

Next, the magnet wire 35 is wound around the stator teeth (i.e., the teeth 40b, the first teeth 51b, and the second teeth 52b) to form the coils 34. At this point in time, the magnet wire 35 is inserted through the U-phase fusing terminal 55U3 and the V-phase fusing terminal 55V3, in the middle of winding the magnet wire 35.

Next, a task of coupling the third W-phase fusing terminal 155W3 to the first end 35a and a task of coupling the fourth W-phase fusing terminal 155W4 to the second end 35b are performed. First, the first end 35a and the second end 35b are inserted respectively through the third W-phase fusing terminal 155W3 and the fourth W-phase fusing terminal 155W4. After insertions, the fusing processes are performed to complete the task of coupling the third W-phase fusing terminal 155W3 to the first end 35a and the task of coupling the fourth W-phase fusing terminal 155W4 to the second end 35b.

At this point in time, the first end 35a and the second end 35b overlap the axially extended region of the coils 34, when viewed from the direction perpendicular to the axial direction of the rotation axis AX.

The task of coupling the third W-phase fusing terminal 155W3 to the first end 35a and the task of coupling the fourth W-phase fusing terminal 155W4 to the second end 35b may be performed in either order. The fusing processes may be performed together with a task of coupling the U-phase fusing terminal 55U3 to the magnet wire 35 and a task of coupling the V-phase fusing terminal 55V3 to the magnet wire 35.

Consequently, the process of coupling the second conductive members 155 to the coils 34 (in other words, the magnet wire 35) is completed.

### 2-2-6. Effects

(1) The second embodiment described above achieves the same effects as in the above-described first embodiment.
(2) In the second embodiment, none of the teeth 40b (in other words, none of the coils 34) is situated between the third W-phase fusing terminal 155W3 and the fourth W-phase fusing terminal 155W4 in the circumferential direction along the annular portion of the yoke 40. Thus, the third W-phase fusing terminal 155W3 and the fourth W-phase fusing terminal 155W4 can be positioned in close proximity to each other, and the magnet wire 35 can be routed such that the first end 35a and the second end 35b are positioned in close proximity to each other.

Consequently, the second electric work machine 101 of the present second embodiment can adopt the same routing path for the magnet wire 35 as when the first end 35a and the second end 35b are coupled to a single connector. Thus, in changing the number of connectors from one to two, a workload for changing the routing path of the magnet wire 35 can be reduced by using the second W-phase conductive member 155W (in other words, the conductive member including the third W-phase fusing terminal 155W3 and the fourth W-phase fusing terminal 155W4).

### 2-2-7. Correspondence between Terms

The third W-phase fusing terminal 155W3 corresponds to an example of the first connector in Overview of Embodiments. The fourth W-phase fusing terminal 155W4 corresponds to an example of the second connector in Overview of Embodiments. The second W-phase fixing hole portion 155W1 corresponds to an example of the power receiver in Overview of Embodiments.

### 2-3. Third Embodiment

### 2-3-1. Differences from First Embodiment

The present third embodiment has a basic configuration similar to that of the first embodiment, and the following describes the differences from the first embodiment. The same reference numerals as those in the first embodiment indicate the same components, and references are made to the preceding descriptions.

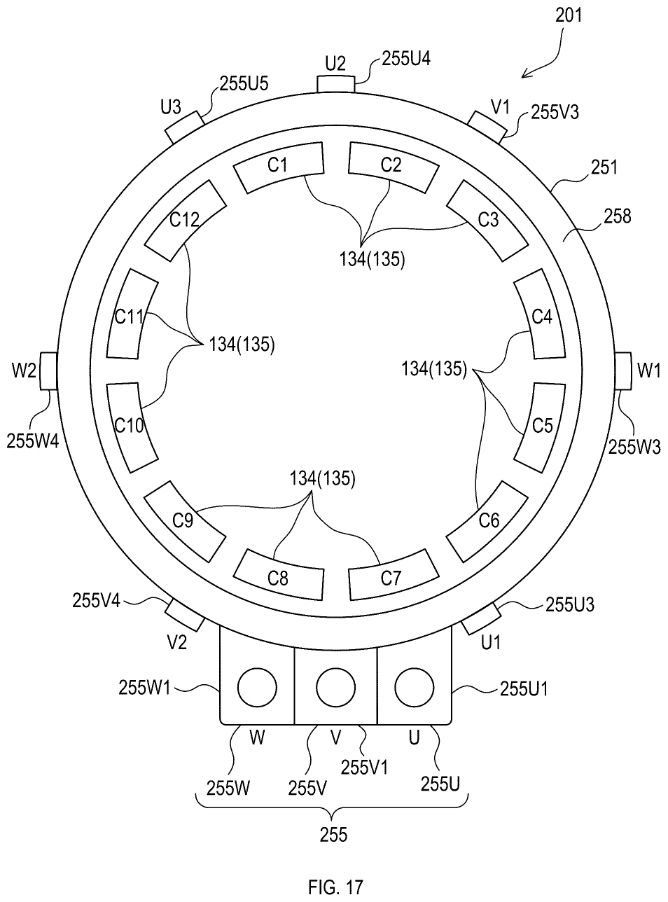

As shown in FIGS. 17 through 20, a third electric work machine 201 of the present third embodiment differs from the electric work machine 1 of the first embodiment in that the third electric work machine 201 includes a third conductive members 255 in place of the conductive members 55, and twelve second coils 134 in place of the six coils 34. Further, the first insulator 51, the stator core 40, and the second insulator 52 in the present third embodiment differ from those in the first embodiment in that they each include twelve teeth. Further, the third electric work machine 201 includes four insulating members 258. The first insulator 51, the stator core 40, and the second insulator 52 in the third embodiment are not shown in the figures.

The present third embodiment exemplifies an eight-pole, twelve-slot, three-phase brushless DC motor.

### 2-3-2. Third Conductive Members

As shown in FIGS. 17 through 20, the third conductive members 255 includes a third U-phase conductive member 255U, a third V-phase conductive member 255V, and a third W-phase conductive member 255W.

The third U-phase conductive member 255U, the third V-phase conductive member 255V, and the third W-phase conductive member 255W are arranged on the rear side of the yoke 40a of the stator core 40 via the second insulator 52. The third U-phase conductive member 255U, the third V-phase conductive member 255V, and the third W-phase conductive member 255W are each shaped to conform to a part of the annular portion of the yoke 40a.

As described later, the third U-phase conductive member 255U, the third V-phase conductive member 255V, and the third W-phase conductive member 255W are stacked from the rear side to the front side in the third electric work machine 201, and electrically insulated from each other by the four insulating members 258.

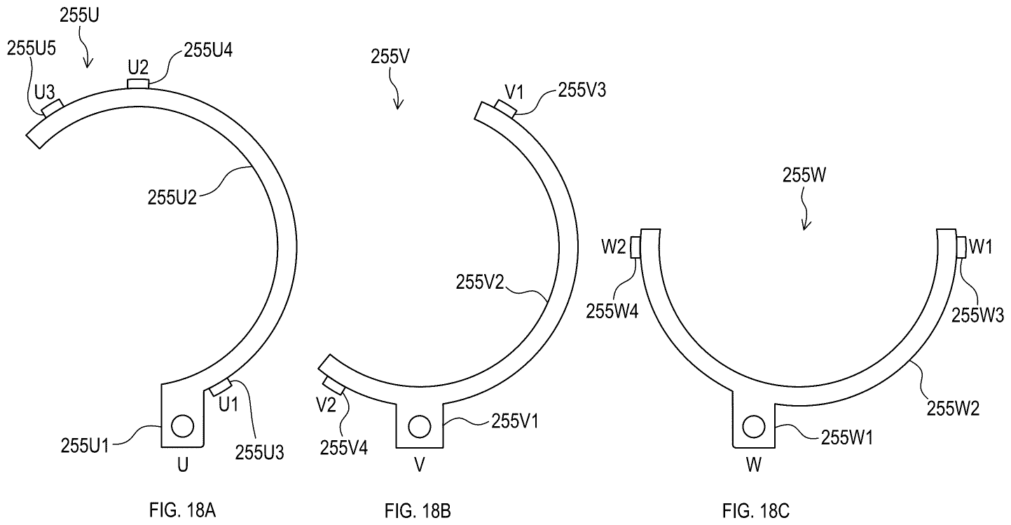

As shown in FIG. 18A, the third U-phase conductive member 255U includes a third U-phase fixing hole portion 255U1, a third U-phase extension 255U2, a first U-phase fusing terminal 255U3, a second U-phase fusing terminal 255U4, and a third U-phase fusing terminal 255U5. The third U-phase fixing hole portion 255U1 has a hole through which the fixation screw 59 can be inserted. The third U-phase extension 255U2 is shaped to conform to a part of the annular portion of the yoke 40a. The third U-phase extension 255U2 electrically couples the third U-phase fixing hole portion 255U1 to the first U-phase fusing terminal 255U3, the second U-phase fusing terminal 255U4, and the third U-phase fusing terminal 255U5.

The first U-phase fusing terminal 255U3, the second U-phase fusing terminal 255U4, and the third U-phase fusing terminal 255U5 are each coupled to a second magnet wire 135 that forms twelve second coils 134 and second connection lines 134a through the fusing process. In other words, the first U-phase fusing terminal 255U3, the second U-phase fusing terminal 255U4, and the third U-phase fusing terminal 255U5 are each electrically coupled to the twelve second coils 134 and the second connection lines 134a.

Similar to the connection lines 34a, the second connection lines 134a are each located between one second coil 134 and another second coil 134, and supported by the first insulator 51 (not shown).

As shown in FIG. 18B, the third V-phase conductive member 255V includes a third V-phase fixing hole portion 255V1, a third V-phase extension 255V2, a first V-phase fusing terminal 255V3, and a second V-phase fusing terminal 255V4. The third V-phase fixing hole portion 255V1 has a hole through which the fixation screw 59 can be inserted. The third V-phase extension 255V2 is shaped to conform to a part of the annular portion of the yoke 40a. The third V-phase extension 255V2 electrically couples the third V-phase fixing hole portion 255V1 to the first W-phase fusing terminal 255V3 and the second W-phase fusing terminal 255V4.

The first V-phase fusing terminal 255V3 and the second V-phase fusing terminal 255V4 are each coupled to the second magnet wire 135 through the fusing process. In other words, the first V-phase fusing terminal 255V3 and the second V-phase fusing terminal 255V4 are each electrically coupled to the twelve second coils 134 and the second connection lines 134a.

As shown in FIG. 18C, the third W-phase conductive member 255W includes a third W-phase fixing hole portion 255W1, a third W-phase extension 255W2, a fifth W-phase fusing terminal 255W3, and a sixth W-phase fusing terminal 255W4. The third W-phase fixing hole portion 255W1 has a hole through which the fixation screw 59 can be inserted. The third W-phase extension 255W2 is shaped to conform to a part of the annular portion of the yoke 40a. The third W-phase extension 255W2 electrically couples the third W-phase fixing hole portion 255W1 to the fifth W-phase fusing terminal 255W3 and the sixth W-phase fusing terminal 255W4.

The fifth W-phase fusing terminal 255W3 and the sixth W-phase fusing terminal 255W4 are each coupled to the second magnet wire 135 through the fusing process. In other words, the fifth W-phase fusing terminal 255W3 and the sixth W-phase fusing terminal 255W4 are each electrically coupled to the twelve second coils 134 and the second connection lines 134a.

Although not shown, the first U-phase fusing terminal 255U3, the second U-phase fusing terminal 255U4, the third U-phase fusing terminal 255U5, the first V-phase fusing terminal 255V3, the second V-phase fusing terminal 255V4, the fifth W-phase fusing terminal 255W3, and the sixth W-phase fusing terminal 255W4 are each formed of the above-described plate member 56.

As shown in FIG. 19 as a schematic exploded view, the four insulating members 258 are configured to electrically insulate the third U-phase conductive member 255U, the third V-phase conductive member 255V, and the third W-phase conductive member 255W from each other. The four insulating members 258 are each made of an insulating material. The four insulating members 258 are each formed in an annular shape that follows the annular portion of the yoke 40a.

The first one of the four insulating members 258 is arranged between the third V-phase conductive member 255V and the third W-phase conductive member 255W. The second one of the four insulating members 258 is arranged between the third U-phase conductive member 255U and the third V-phase conductive member 255V. The third one of the four insulating members 258 is arranged on a side of the third U-phase conductive member 255U opposite to a side facing the third V-phase conductive member 255V. The fourth one of the four insulating members 258 is arranged on a side of the third W-phase conductive member 255W opposite to a side facing the third V-phase conductive member 255V.

In other words, the third U-phase conductive member 255U, the third V-phase conductive member 255V, and the third W-phase conductive member 255W, and the four insulating members 258 are arranged on the rear side of the yoke 40a of the stator core 40 via the second insulator 52.

In other words, the third U-phase conductive member 255U, the third V-phase conductive member 255V, and the third W-phase conductive member 255W are stacked from the rear side to the front side in the third electric work machine 201, and electrically insulated from each other by the four insulating members 258.

The insulating member 258 arranged on the front side of the third W-phase conductive member 255W is stacked on and in contact with the second insulator 52. In other words, this insulating member 258 is stacked on the second insulator 52 on a side of the second insulator 52 opposite to a side facing the stator core 40 in the axial direction of the rotation axis AX.

The third U-phase conductive member 255U, the third V-phase conductive member 255V, and the third W-phase conductive member 255W are not necessarily stacked in this order from the rear side to the front side in the third electric work machine 201, and may be stacked in this order from the front side to the rear side.

The third W-phase conductive member 255W is not necessarily stacked on the second insulator 52 indirectly in contact with the second insulator 52 via the insulating member 258. The third W-phase conductive member 255W may be stacked on the second insulator 52 directly in contact with the second insulator 52 without the insulating member 258. In other words, the third W-phase conductive member 255W may be stacked on the second insulator 52 directly in contact with the second insulator 52 on a side of the second insulator 52 opposite to a side facing the stator core 40 in the axial direction of the rotation axis AX.

An assembly process for assembling the third U-phase conductive member 255U, the third V-phase conductive member 255V, the third W-phase conductive member 255W, and the four insulating members 258 together may include forming these members individually beforehand, and stacking the members in the above-described configuration.

Alternatively, the assembly process may include arranging the third U-phase conductive member 255U, the third V-phase conductive member 255V, and the third W-phase conductive member 255W apart from each other inside a formwork, pouring liquid insulating material into the formwork, and solidifying the insulating material to form four insulating members 258. In this case, an insulating connector configured to couple the four insulating members 258 together may be provided. The insulating connector may be arranged in a stacking direction of the four insulating members 258 to couple the four insulating members 258 together. The insulating connector may be provided as a member to bring the third U-phase conductive member 255U, the third V-phase conductive member 255V, the third W-phase conductive member 255W, and the four insulating members 258 together.

### 2-3-3. Electrical Connection between Coils and Conductive Members

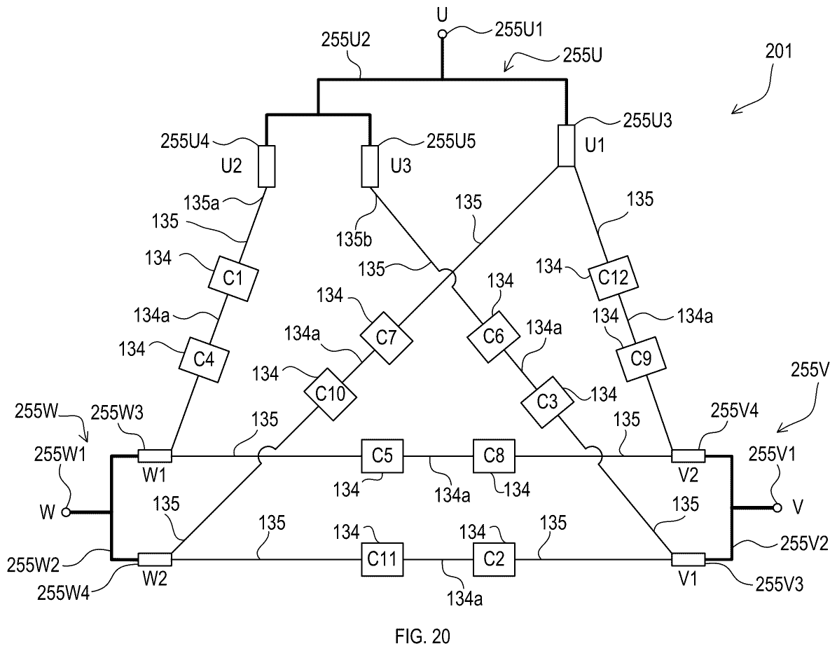

As schematically shown in FIG. 20, the twelve second coils 134 include first through twelfth coils C1 through C12. The first through twelfth coils C1 through C12 are formed from a single second magnet wire 135. The second magnet wire 135 includes a first end 135a and a second end 135b. The second magnet wire 135 is arranged, starting from the first end 135a, in the order of the first coil C1, the fourth coil C4, the fifth coil C5, the eighth coil C8, the ninth coil C9, the twelfth coil C12, the seventh coil C7, the tenth coil C10, the eleventh coil C11, the second coil C2, the third coil C3, and the sixth coil C6, to reach the second end 135b.

Wire routing order when the first through twelfth coils C1 through C12 are formed from the single second wire 135 is not limited to the above-described order, and may be other orders. In other words, the order of forming the first through twelfth coils C1 through C12 may be defined as desired.

The first end 135a of the second magnet wire 135 is coupled to the second U-phase fusing terminal 255U4. The second end 135b of the second magnet wire 135 is coupled to the third U-phase fusing terminal 255U5.

A portion of the second magnet wire 135 between the fourth coil C4 and the fifth coil C5 is coupled to the fifth W-phase fusing terminal 255W3. A portion of the second magnet wire 135 between the eighth coil C8 and the ninth coil C9 is coupled to the second V-phase fusing terminal 255V4. A portion of the second magnet wire 135 between the twelfth coil C12 and the seventh coil C7 is coupled to the first U-phase fusing terminal 255U3. A portion of the second magnet wire 135 between the tenth coil C10 and the eleventh coil C11 is coupled to the sixth W-phase fusing terminal 255W4. A portion of the second magnet wire 135 between the second coil C2 and the third coil C3 is coupled to the first V-phase fusing terminal 255V3.

The second connection lines 134a correspond to portions of the second magnet wire 135 between the first coil C1 and the fourth coil C4, between the fifth coil C5 and the eighth coil C8, between the ninth coil C9 and the twelfth coil C12, between the seventh coil C7 and the tenth coil C10, between the eleventh coil C11 and the second coil C2, and between the third coil C3 and the sixth coil C6.

### 2-3-4. Process of Coupling Conductive Members to Coils

A process of coupling the third conductive members 255 to the second coils 134 (in other words, the second magnet wire 135) will be described.

First, the third conductive members 255 (i.e., the third U-phase conductive member 255U, the third V-phase conductive member 255V, and the third W-phase conductive member 255W) are arranged with respect to the first insulator 51, the stator core 40, and the second insulator 52 assembled together. In detail, the third conductive members 255 are arranged on the yoke 40a via the second insulator 52 in the axial direction of the rotation axis AX.

The second U-phase fusing terminal 255U4 is offset from the third U-phase fusing terminal 255U5 in the circumferential direction along the annular portion of the yoke 40a (in other words, in the circumferential direction of the rotation axis AX).

In addition, the second U-phase fusing terminal 255U4 is aligned with the third U-phase fusing terminal 255U5 across the axial direction of the rotation axis AX.

Next, the second magnet wire 135 is wound around the stator teeth (i.e., the teeth 40b, the first teeth 51b, and the second teeth 52b) to form the twelve second coils 134. At this point in time, in the middle of winding the second magnet wire 135, the second magnet wire 135 is inserted through the first V-phase fusing terminal 255V3, the fifth W-phase fusing terminal 255W3, the first U-phase fusing terminal 255U3, the second V-phase fusing terminal 255V4, and the sixth W-phase fusing terminal 255W4.

Next, a task of coupling the second U-phase fusing terminal 255U4 to the first end 135a and a task of coupling the third U-phase fusing terminal 255U5 to the second end 135b are performed. First, the first end 135a and the second end 135b are inserted respectively through the second U-phase fusing terminal 255U4 and the third U-phase fusing terminal 255U5. After insertions, the fusing processes are performed to complete the task of coupling the second U-phase fusing terminal 255U4 to the first end 135a and the task of coupling the third U-phase fusing terminal 255U5 to the second end 135b.

At this point in time, the first end 135a and the second end 135b overlap the axially extended region of the second coils 134, when viewed from the direction perpendicular to the axial direction of the rotation axis AX.

The task of coupling the second U-phase fusing terminal 255U4 to the first end 135a and the task of coupling the third U-phase fusing terminal 255U5 to the second end 135b may be performed in either order. The fusing processes may be performed together with tasks of coupling the other fusing terminals to the second magnet wire 135.

Consequently, the process of coupling the third conductive members 255 to the twelve second coils 134 (in other words, the second magnet wire 135) is completed.

### 2-3-5. Effects

(1) The third embodiment described above achieves the same effects as in the above-described first embodiment.
(2) The third embodiment exemplifies the eight-pole, twelve-slot, three-phase brushless DC motor. Thus, axial dimensions can be reduced not only for eight-pole, six-slot, three-phase brushless DC motors as in the first and second embodiments but also for eight-pole, twelve-slot, three-phase brushless DC motors.

### 2-3-6. Correspondence between Terms

The second U-phase fusing terminal 255U4 corresponds to an example of the first connector in Overview of Embodiments. The third U-phase fusing terminal 255U5 corresponds to an example of the second connector in Overview of Embodiments. The third U-phase fixing hole portion 255U1, the third V-phase fixing hole portion 255V1, and the third W-phase fixing hole portion 255W1 correspond to an example of the power receiver in Overview of Embodiments.

### 2-4. Fourth Embodiment

### 2-4-1. Differences from Third Embodiment

The present fourth embodiment has a basic configuration similar to that of the third embodiment, and the following describes the differences from the third embodiment. The same reference numerals as those in the third embodiment indicate the same components, and references are made to the preceding descriptions.

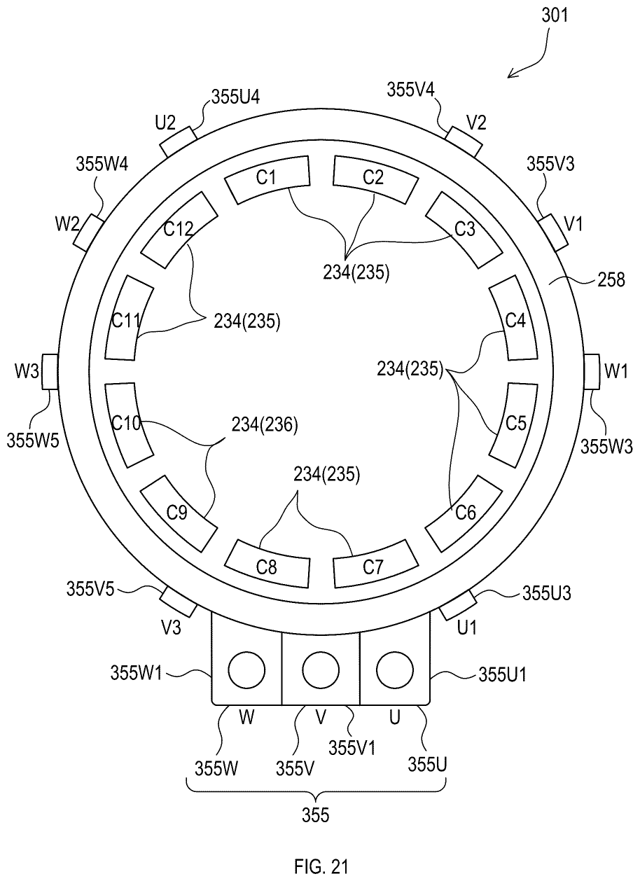

As shown in FIGS. 21 through 24, a fourth electric work machine 301 of the present fourth embodiment differs from the third electric work machine 201 of the third embodiment in that the fourth electric work machine 301 includes fourth conductive members 355 in place of the third conductive members 255, and the twelve coils (the twelve third coils 234, in detail) are formed from two magnet wires (a third magnet wire 235 and a fourth magnet wire 236, in detail). Similar to the third electric work machine 201, the fourth electric work machine 301 includes the four insulating members 258.

### 2-4-2. Fourth Conductive Members

As shown in FIGS. 21 through 24, the fourth conductive members 355 includes a fourth U-phase conductive member 355U, a fourth V-phase conductive member 355V, and a fourth W-phase conductive member 355W.

The fourth U-phase conductive member 355U, the fourth V-phase conductive member 355V, and the fourth W-phase conductive member 355W are arranged on the rear side of the yoke 40a of the stator core 40 via the second insulator 52. The fourth U-phase conductive member 355U, the fourth V-phase conductive member 355V, and the fourth W-phase conductive member 355W are each shaped to conform to a part of the annular portion of the yoke 40a.

As described later, the fourth U-phase conductive member 355U, the fourth V-phase conductive member 355V, and the fourth W-phase conductive member 355W are stacked from the rear side to the front side in the fourth electric work machine 301, and electrically insulated from each other by the insulating members 258.

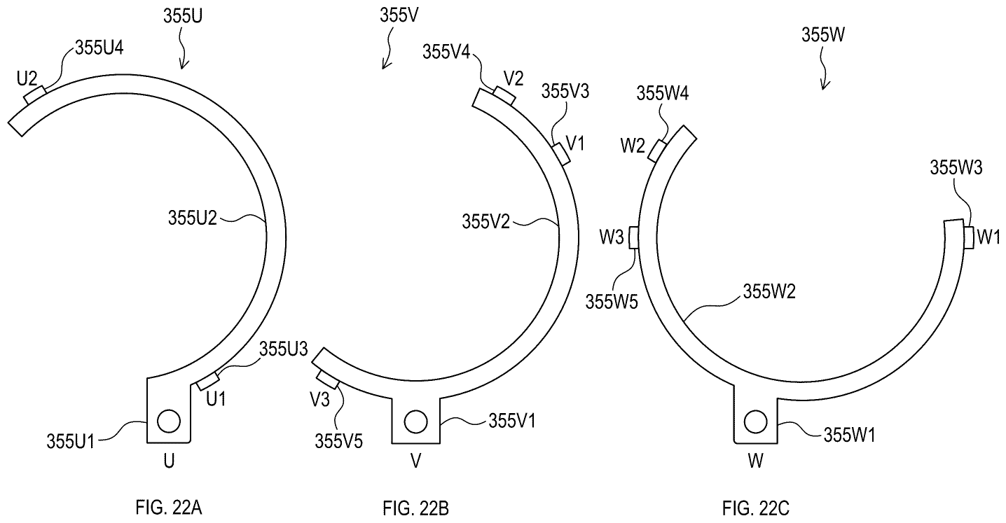

As shown in FIG. 22A, the fourth U-phase conductive member 355U includes a fourth U-phase fixing hole portion 355U1, a fourth U-phase extension 355U2, a third U-phase fusing terminal 355U3, and a fourth U-phase fusing terminal 355U4. The fourth U-phase fixing hole portion 355U1 has a hole through which the fixation screw 59 can be inserted. The fourth U-phase extension 355U2 is shaped to conform to a part of the annular portion of the yoke 40a. The fourth U-phase extension 355U2 electrically couples the fourth U-phase fixing hole portion 355U1 to the third U-phase fusing terminal 355U3 and the fourth U-phase fusing terminal 355U4. The third U-phase fusing terminal 355U3 and the fourth U-phase fusing terminal 355U4 are each coupled to the third magnet wire 235 through the fusing process. In other words, the third U-phase fusing terminal 355U3 and the fourth U-phase fusing terminal 355U4 are each electrically coupled to the twelve third coils 234 and third connection lines 234a.

Similar to the second connection lines 134a, the third connection lines 234a are each located between one third coil 234 and another third coil 234, and supported by the first insulator 51 (not shown).

As shown in FIG. 22B, the fourth V-phase conductive member 355V includes a fourth V-phase fixing hole portion 355V1, a fourth V-phase extension 355V2, a third V-phase fusing terminal 355V3, a fourth V-phase fusing terminal 355V4, and a fifth V-phase fusing terminal 355V5. The fourth V-phase fixing hole portion 355V1 has a hole through which the fixation screw 59 can be inserted. The fourth V-phase extension 355V2 is shaped to conform to a part of the annular portion of the yoke 40a. The fourth V-phase extension 355V2 electrically couples the fourth V-phase fixing hole portion 355V1 to the third W-phase fusing terminal 355V3, the fourth W-phase fusing terminal 355V4, and the fifth W-phase fusing terminal 355V5.

The third V-phase fusing terminal 355V3 is coupled to the fourth magnet wire 236 through the fusing process. The fourth V-phase fusing terminal 355V4 and the fifth V-phase fusing terminal 355V5 are coupled to the third magnet wire 235 through the fusing process. In other words, the third V-phase fusing terminal 355V3, the fourth V-phase fusing terminal 355V4, and the fifth V-phase fusing terminal 355V5 are each electrically coupled to the twelve third coils 234 and the third connection lines 234a.

As shown in FIG. 22C, the fourth W-phase conductive member 355W includes a fourth W-phase fixing hole portion 355W1, a fourth W-phase extension 355W2, a seventh W-phase fusing terminal 355W3, an eighth W-phase fusing terminal 355W4, and a ninth W-phase fusing terminal 355W5. The fourth W-phase fixing hole portion 355W1 has a hole through which the fixation screw 59 can be inserted. The fourth W-phase extension 355W2 is shaped to conform to a part of the annular portion of the yoke 40a. The fourth W-phase extension 355W2 electrically couples the fourth W-phase fixing hole portion 355W1 to the seventh W-phase fusing terminal 355W3, the eighth W-phase fusing terminal 355W4, and the ninth W-phase fusing terminal 355W5.

The seventh W-phase fusing terminal 355W3 and the eighth W-phase fusing terminal 355W4 are each coupled to the third magnet wire 235 through the fusing process. The ninth W-phase fusing terminal 355W5 is coupled to the fourth magnet wire 236 through the fusing process. In other words, the seventh W-phase fusing terminal 355W3, the eighth W-phase fusing terminal 355W4, and the ninth W-phase fusing terminal 355W5 are each electrically coupled to the twelve third coils 234 and the third connection lines 234a.

Although not shown, the third U-phase fusing terminal 355U3, the fourth U-phase fusing terminal 355U4, the third V-phase fusing terminal 355V3, the fourth V-phase fusing terminal 355V4, the fifth V-phase fusing terminal 355V5, the seventh W-phase fusing terminal 355W3, the eighth W-phase fusing terminal 355W4, and the ninth W-phase fusing terminal 355W5 are each formed of the above-described plate member 56.

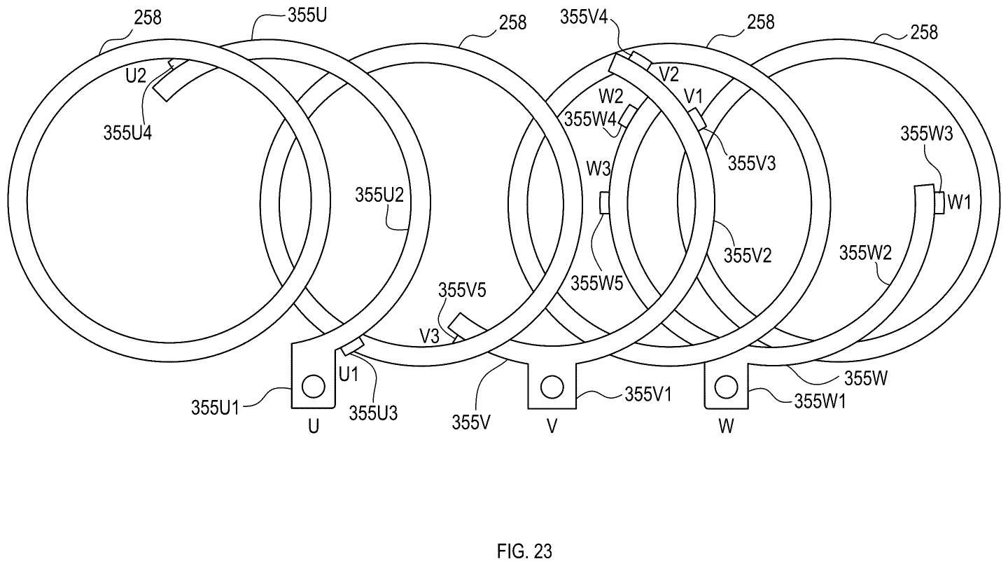

As shown in FIG. 23 as a schematic exploded view, the four insulating members 258 are configured to electrically insulate the fourth U-phase conductive member 355U, the fourth V-phase conductive member 355V, and the fourth W-phase conductive member 355W from each other. The four insulating members 258 are configured in the same manner as the four insulating members 258 of the third embodiment.

The first one of the four insulating members 258 is arranged between the fourth V-phase conductive member 355V and the fourth W-phase conductive member 355W. The second one of the four insulating members 258 is arranged between the fourth U-phase conductive member 355U and the fourth V-phase conductive member 355V. The third one of the four insulating members 258 is arranged on a side of the fourth U-phase conductive member 355U opposite to a side facing the fourth V-phase conductive member 355V. The fourth one of the four insulating members 258 is arranged on a side of the fourth W-phase conductive member 355W opposite to a side facing the fourth V-phase conductive member 355V.

In other words, the fourth U-phase conductive member 355U, the fourth V-phase conductive member 355V, the fourth W-phase conductive member 355W, and the four insulating members 258 are arranged on the rear side of the yoke 40a of the stator core 40 via the second insulator 52.

In other words, the fourth U-phase conductive member 355U, the fourth V-phase conductive member 355V, and the fourth W-phase conductive member 355W are stacked from the rear side to the front side in the fourth electric work machine 301, and electrically insulated from each other by the four insulating members 258.

The insulating member 258 arranged on the front side of the fourth W-phase conductive member 355W is stacked on and in contact with the second insulator 52. In other words, this insulating member 258 is stacked on the second insulator 52 on a side of the second insulator 52 opposite to a side facing the stator core 40 in the axial direction of the rotation axis AX.

The fourth U-phase conductive member 355U, the fourth V-phase conductive member 355V, and the fourth W-phase conductive member 355W are not necessarily stacked in this order from the rear side to the front side in the fourth electric work machine 301, and may be stacked in this order from the front side to the rear side.

The fourth W-phase conductive member 355W is not necessarily stacked on the second insulator 52 in indirect contact with the second insulator 52 via the insulating member 258. The fourth W-phase conductive member 355W may be stacked on the second insulator 52 and in direct contact with the second insulator 52 without the insulating member 258. In other words, the fourth W-phase conductive member 355W may be stacked on and in direct contact with the second insulator 52 on a side of the second insulator 52 opposite to a side facing the stator core 40 in the axial direction of the rotation axis AX.

An assembly process for assembling the fourth U-phase conductive member 355U, the fourth V-phase conductive member 355V, the fourth W-phase conductive member 355W, and the four insulating members 258 together may include forming these members individually beforehand, and stacking the members in the above-described configuration, as in the third embodiment. Alternatively, the assembly process may include arranging the fourth U-phase conductive member 355U, the fourth V-phase conductive member 355V, and the fourth W-phase conductive member 355W apart from each other inside a formwork, pouring liquid insulating material into the formwork, and solidifying the insulating material to form four insulating members 258.

### 2-4-3. Electrical Connection between Coils and Conductive Members

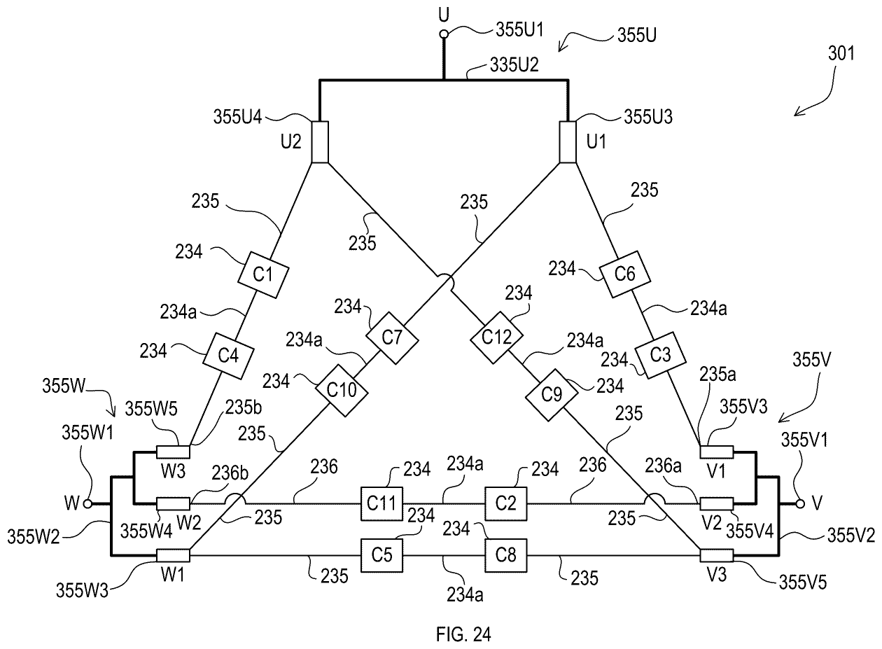

As schematically shown in FIG. 24, the twelve third coils 234 include first through twelfth coils C1 through C12. Each of the first through twelfth coils 234 is formed from either the third magnet wire 235 or the fourth magnet wire 236.

The third magnet wire 235 includes its first end 235a and its second end 235b. The third magnet wire 235 is arranged, starting from the first end 235a, in the order of the third coil C3, the sixth coil C6, the seventh coil C7, the tenth coil C10, the fifth coil C5, the eighth coil C8, the ninth coil C9, the twelfth coil C12, the first coil C1, and the fourth coil C4, to reach the second end 235b. The fourth magnet wire 236 is arranged, starting from its first end 236a, in the order of the eleventh coil C11 and the second coil C2, to reach its second end 236b.

Wire routing order when the first coil C1, the third through tenth coils C3 through C10, and the twelfth coil C12 are formed from the single third magnet wire 235 is not limited to the above order, and may be other orders. Wire routing order when the eleventh coil C11 and the second coil C2 are formed from the single fourth magnet wire 236 is not limited to the above order, and may be the order of the second coil C2 and the eleventh coil C11. In other words, the order of forming the first coil C1, the third through tenth coils C3 through C10, and the twelfth coil C12 and the order of forming the eleventh coil C11 and the second coil C2 are defined as desired.

The first end 235a of the third magnet wire 235 is coupled to the third V-phase fusing terminal 355V3. The second end 235b of the third magnet wire 235 is coupled to the ninth W-phase fusing terminal 355W5. The first end 236a of the fourth magnet wire 236 is coupled to the fifth V-phase fusing terminal 355V5. The second end 236b of the fourth magnet wire 236 is coupled to the eighth W-phase fusing terminal 355W4.

A portion of the third magnet wire 235 between the sixth coil C6 and the seventh coil C7 is coupled to the third U-phase fusing terminal 355U3. A portion of the third magnet wire 235 between the tenth coil C10 and the fifth coil C5 is coupled to the seventh W-phase fusing terminal 355W3. A portion of the third magnet wire 235 between the eighth coil C8 and the ninth coil C9 is coupled to the fifth V-phase fusing terminal 355V5. A portion of the third magnet wire 235 between the twelfth coil C12 and the first coil C1 is coupled to the fourth U-phase fusing terminal 355U4.

The third connection lines 234a correspond to portions of the third magnet wire 235 between the third coil C3 and the sixth coil C6, between the seventh coil C7 and the tenth coil C10, between the fifth coil C5 and the eighth coil C8, between the ninth coil C9 and the twelfth coil C12, and between the first coil C1 and the fourth coil C4. Also, the third connection lines 234a correspond to the portion of the fourth magnet wire 236 between the second coil C2 and the eleventh coil C11.

### 2-4-4. Process of Coupling Conductive Members to Coils

A process of coupling the fourth conductive members 355 to the third coils 234 (in other words, the third magnet wire 235 and the fourth magnet wire 236) will be described.

First, the fourth conductive members 355 (i.e., the fourth U-phase conductive member 355U, the fourth V-phase conductive member 355V, and the fourth W-phase conductive member 355W) are arranged with respect to the first insulator 51, the stator core 40, and the second insulator 52 assembled together. In detail, the fourth conductive members 355 are arranged on the yoke 40a via the second insulator 52 in the axial direction of the rotation axis AX.

The eighth W-phase fusing terminal 355W4, the fifth V-phase fusing terminal 355V5, the third V-phase fusing terminal 355V3, and the ninth W-phase fusing terminal 355W5 are offset from each other in the circumferential direction along the annular portion of the yoke 40a (in other words, in the circumferential direction of the rotation axis AX).

In addition, the eighth W-phase fusing terminal 355W4, the fifth V-phase fusing terminal 355V5, the third V-phase fusing terminal 355V3, and the ninth W-phase fusing terminal 355W5 are aligned with each other across the axial direction of the rotation axis AX.

Next, the third magnet wire 235 and the fourth magnet wire 236 are wound around the stator teeth (i.e., the teeth 40b, the first teeth 51b, and the second teeth 52b) to form the twelve third coils 234. At this point in time, in the middle of winding the third magnet wire 235, the third magnet wire 235 is inserted through the fourth U-phase fusing terminal 355U4, the fourth V-phase fusing terminal 355V4, the seventh W-phase fusing terminal 355W3, and the third U-phase fusing terminal 355U3.

Next, a task of coupling the first end 235a to the eighth W-phase fusing terminal 355W4, a task of coupling the second end 235b to the fifth V-phase fusing terminal 355V5, a task of coupling the first end 236a to the third V-phase fusing terminal 355V3, and a task of coupling the second end 236b to the ninth W-phase fusing terminal 355W5 are performed.

First, the first end 235a, the second end 235b, the first end 236a, and the second end 236b are inserted respectively through the eighth W-phase fusing terminal 355W4, the fifth V-phase fusing terminal 355V5, the third V-phase fusing terminal 355V3, and the ninth W-phase fusing terminal 355W5. After insertions, the fusing processes are performed to complete the task of coupling the first end 235a to the eighth W-phase fusing terminal 355W4, the task of coupling the second end 235b to the fifth V-phase fusing terminal 355V5, the task of coupling the first end 236a to the third V-phase fusing terminal 355V3, and the task of coupling the second end 236b to the ninth W-phase fusing terminal 355W5.

At this point in time, the first end 235a, the second end 235b, the first end 236a, and the second end 236b overlap the axially extended region of the third coils 234, when viewed from the direction perpendicular to the axial direction of the rotation axis AX.

Any of the first end 235a, the second end 235b, the first end 236a, and the second end 236b may be coupled first to a corresponding fusing terminal, and the order from the second onward may be determined as desired. The fusing processes may be performed together with tasks of coupling the other fusing terminals to the third magnet wire 235.

Consequently, the process of coupling the fourth conductive members 355 to the twelve third coils 234 (in other words, the third magnet wire 235 and the fourth magnet wire 236) is completed.

### 2-4-5. Effects

(1) The fourth embodiment described above achieves the same effects as in the above-described third embodiment.
(2) In the fourth embodiment, the twelve third coils 234 are formed from the third magnet wire 235 and the fourth magnet wire 236. The third magnet wire 235 includes the first end 235a and the second end 235b. The fourth magnet wire 236 includes the first end 236a and the second end 236b. The first end 235a, the second end 235b, the first end 236a, and the second end 236b are aligned with each other across the axial direction of the rotation axis AX.

Thus, the axial dimension of the motor 25 can be reduced, compared to one with the first end 235a, the second end 235b, the first end 236a, and the second end 236b are offset from each other in the axial direction.

Therefore, the fourth electric work machine 301 can be inhibited from increasing in size.
(3) The fourth V-phase conductive member 355V electrically couples the eighth coil C8 and the ninth coil C9 to each other. The fourth W-phase conductive member 355W electrically couples the tenth coil C10 and the eleventh coil C11 to each other. With this configuration, it is possible to dispense with crossover wires for electrically coupling different coils.

### 2-4-6. Correspondence between Terms

Each of the eighth W-phase fusing terminal 355W4 and the third V-phase fusing terminal 355V3 corresponds to an example of the first connector in Overview of Embodiments. Each of the fifth V-phase fusing terminal 355V5 and the ninth W-phase fusing terminal 355W5 corresponds to an example of the second connector in Overview of Embodiments. The fourth U-phase fixing hole portion 355U1, the fourth V-phase fixing hole portion 355V1, and the fourth W-phase fixing hole portion 355W1 correspond to an example of the power receiver in Overview of Embodiments.

### 2-5. Other Embodiments

The embodiments of the present disclosure have been described in the above. The present disclosure is not limited to the above-described embodiments, and can be practiced in various forms.
(a) In the above-described first through fourth embodiments, the configurations using the single magnetic wire or the two magnet wires are described. However, the present disclosure is not limited to these configurations. The coils may be formed from three or more magnet wires.

The coils may be formed from two or more but a smaller number of magnet wires than the coils. With such a configuration, both ends (in other words, the first end and the second end) of the respective magnet wires can be inhibited from being offset from each other in the axial direction.
(b) In the above-described first through fourth embodiments, the configurations with the six coils or the twelve coils are described. However, the present disclosure is not limited to these configurations. The number of coils may be any multiple of three, except for six and twelve.
(c) In the above-described first through fourth embodiments, the eight-pole, six-slot, three-phase brushless DC motors and the eight-pole, twelve-slot, three-phase brushless DC motor are described. However, the present disclosure is not limited to these configurations. Brushless DC motors according to the present disclosure may include any number of poles and any number of teeth or slots. One example of a brushless DC motor according to the present disclosure may include twelve poles and nine slots. Another example of a brushless DC motor according to the present disclosure may include four poles and six slots.
(d) Two or more functions achieved by one element of the above-described embodiments may be achieved by two or more elements. One function achieved by one element may be achieved by two or more elements. Two or more functions achieved by two or more elements may be achieved by one element. One function achieved by two or more elements may be achieved by one element. A part of the configurations in the above-described embodiments may be omitted. At least a part of the configurations in one of the above-described embodiments may be added to or replaced with a part of the configurations in another one of the above-described embodiments.

What is claimed is:

1. An electric work machine comprising:
a brushless DC motor including: a rotor configured to rotate about a rotation axis; and
a stator surrounding the rotor,
the stator including:
a stator core including a yoke surrounding the rotor and teeth protruding radially inward from the yoke;
an insulator covering at least a portion of the stator core;
coils formed from at least one magnet wire wound around the teeth via the insulator; and
a conductive member including: a first connector coupled to a first end of one of the at least one magnet wire; and a second connector coupled to a second end of the one of the at least one magnet wire,
the conductive member being stacked on the yoke via the insulator in an axial direction of the rotation axis,
the first connector being offset from the second connector in a circumferential direction of the rotation axis but aligned with the second connector across the axial direction, and
the first connector and the second connector overlapping an axially extended region of the coils, when viewed from a direction perpendicular to the axial direction.

2. The electric work machine according to claim 1, wherein:
the first connector and the second connector are each formed of a plate member that is bent such that its cross section has a U-shape, and a first extension direction connecting an open end and a closed end of the U-shape is arranged parallel to the axial direction;
the first connector is coupled to the first end arranged in an inside of the U-shaped; and
the second connector is coupled to the second end arranged in the inside of the U-shape.

3. The electric work machine according to claim 1,
wherein the first connector and the second connector are arranged such that a gap between the first connector and the second connector in the circumferential direction is larger than or equal to a width of one of the teeth in the circumferential direction.

4. The electric work machine according to claim 1,
wherein the first connector and the second connector are arranged such that a gap between the first connector and the second connector in the circumferential direction is smaller than a width of one of the teeth in the circumferential direction.

5. The electric work machine according to claim 1,
wherein the at least one magnetic wire is a single magnetic wire.

6. The electric work machine according to claim 1,
wherein the at least one magnet wire is two or more but a smaller number of magnetic wires than the coils.

7. The electric work machine according to claim 1, further comprising
a rotational position sensor configured to detect a rotational position of the rotor,
wherein the rotational position sensor is arranged on the stator core opposite to the conductive member in the axial direction.

8. The electric work machine according to claim 1,
wherein the first connector and the second connector overlap the stator core, as viewed from the axial direction.

9. The electric work machine according to claim 1,
wherein the conductive member electrically couples different two of the coils to each other.

10. The electric work machine according to claim 1,
wherein the coils include a multiple of three coils.

11. The electric work machine according to claim 10, wherein:
the rotor includes eight magnetic poles; and
the stator includes six slots.

12. The electric work machine according to claim 1,
wherein the conductive member is directly or indirectly in contact with the insulator.

13. The electric work machine according to claim 1,
wherein the conductive member further includes a power receiver configured to receive electric power for the coils.

14. The electric work machine according to claim 1, further comprising
a housing accommodating the brushless DC motor therein.
